(19) United States
(12) Patent Application Publication
(10) Pub. No.: US 2017/0255895 A1
(43) Pub. Date: Sep. 7, 2017

(54) EVALUATION DEVICE AND EVALUATION METHOD

(71) Applicant: Komatsu Ltd., Tokyo (JP)

(72) Inventors: Susumu Kozumi, Tokyo (JP); Hidemi Takahashi, Tokyo (JP); Hiroki Akanuma, Tokyo (JP); Hisashi Asada, Tokyo (JP)

(73) Assignee: Komatsu Ltd., Tokyo (JP)

(21) Appl. No.: 15/128,210

(22) PCT Filed: Mar. 1, 2016
(86) PCT No.: PCT/JP2016/056290

§ 371 Date: Sep. 22, 2016

(51) Int. Cl. G06Q 10/06; G06T 7/70; H04N 7/18; E02F 9/26; G07C 5/08

(52) U.S. Cl. CPC G06Q 10/063114; E02F 9/26; G07C 5/0841; G07C 5/0808; G07C 5/0816; H04N 7/185; G06T 7/70; E02F 3/32

(57) ABSTRACT

An evaluation device includes a detection data acquisition unit that acquires detection data including a detected movement trajectory of a predetermined portion of a working unit of a working vehicle based on operation data of the working unit from a movement starting position to a movement ending position, detected by a detection device that detects an operation of the working unit, a target data generation unit that generates target data including a target movement trajectory of the predetermined portion of the working unit, and an evaluation data generation unit that generates evaluation data of an operator who operates the working unit based on the detection data and the target data.

### FIELD

The present invention relates to an evaluation device and an evaluation method.

### BACKGROUND

When an operator operates a working vehicle to perform a construction operation, the construction efficiency changes depending on the skill of the operator. Patent Literature 1 discloses a technique of evaluating the degree of the operator's skill.

### CITATION LIST

### Patent Literature

Patent Literature 1: Japanese Patent Application Laid-open No. 2009-235833

### SUMMARY

### Technical Problem

When the operator's skill can be evaluated objectively, the points of improvement for operation become clear, and the operator will be encouraged to improve the skill.

An object of some aspects of the present invention is to provide an evaluation device and an evaluation method capable of evaluating the operator's skill of a working vehicle objectively.

### Solution to Problem

According to a first aspect of the present invention, an evaluation device comprises: a detection data acquisition unit that acquires detection data including a detected movement trajectory of a predetermined portion of a working unit of a working vehicle based on operation data of the working unit from a movement starting position to a movement ending position, detected by a detection device that detects an operation of the working unit; a target data generation unit that generates target data including a target movement trajectory of the predetermined portion of the working unit; and an evaluation data generation unit that generates evaluation data of an operator who operates the working unit based on the detection data and the target data.

According to a second aspect of the present invention, an evaluation device comprises: a detection data acquisition unit that acquires, based on operation data of a working unit of a working vehicle, first detection data indicating an excavation amount of the working unit and second detection data indicating an excavation period of the working unit; and an evaluation data generation unit that generates evaluation data of an operator who operates the working unit based on the first detection data and the second detection data.

According to a third aspect of the present invention, an evaluation method comprises: acquiring detection data including a detected movement trajectory of a predetermined portion of a working unit of a working vehicle based on operation data of the working unit from a movement starting position to a movement ending position of the working unit, detected by a detection device that detects an operation of the working unit; generating target data including a target movement trajectory of the predetermined portion of the working unit; and generating evaluation data of an operator who operates the working unit based on the detection data and the target data.

According to a fourth aspect of the present invention, an evaluation method comprises: acquiring first detection data indicating an excavation amount of a working unit of a working vehicle and second detection data indicating an excavation period of the working unit based on operation data of the working unit; and generating evaluation data of an operator who operates the working unit based on the first detection data and the second detection data.

### Advantageous Effects of Invention

According to the aspects of the present invention, an evaluation device and an evaluation method capable of evaluating the operator's skill of a working vehicle objectively are provided.

### BRIEF DESCRIPTION OF DRAWINGS

FIG. 1 is a diagram schematically illustrating an example of an evaluation system according to a first embodiment.

FIG. 2 is a side view illustrating an example of an excavator according to the first embodiment.

FIG. 3 is a plan view illustrating an example of an excavator according to the first embodiment.

FIG. 4 is a diagram schematically illustrating an example of an operating device according to the first embodiment.

FIG. 5 is a diagram schematically illustrating an example of a hardware configuration of the evaluation system according to the first embodiment.

FIG. 6 is a functional block diagram illustrating an example of a mobile device according to the first embodiment.

FIG. 7 is a flowchart illustrating an example of an evaluation method according to the first embodiment.

FIG. 8 is a flowchart illustrating an example of a photographing preparation method according to the first embodiment.

FIG. 9 is a diagram for describing an example of a photographing method according to the first embodiment.

FIG. 10 is a diagram for describing a method of specifying the position of an upper swing structure according to the first embodiment.

FIG. 11 is a diagram for describing a method of specifying the position of a working unit according to the first embodiment.

FIG. 12 is a schematic diagram for describing an example of an evaluation method according to the first embodiment.

FIG. 13 is a flowchart illustrating an example of a photographing and evaluation method according to the first embodiment.

FIG. 14 is a diagram for describing a method of specifying a movement starting position of a working unit according to the first embodiment.

FIG. 15 is a diagram for describing a method of acquiring photographic data including a detected movement trajectory of a working unit according to the first embodiment.

FIG. 16 is a diagram for describing a method of acquiring photographic data including a detected movement trajectory of a working unit according to the first embodiment.

FIG. 17 is a diagram for describing a method of specifying a movement ending position of a working unit according to the first embodiment.

FIG. 18 is a diagram for describing a method of generating target data indicating a target movement trajectory of a working unit according to the first embodiment.

FIG. 19 is a diagram for describing an evaluation data display method according to the first embodiment.

FIG. 20 is a diagram for describing an example of a relative data display method according to the first embodiment.

FIG. 21 is a diagram for describing an example of an operator evaluation method according to the first embodiment.

FIG. 22 is a diagram for describing an operator evaluation method according to the first embodiment.

FIG. 23 is a functional block diagram illustrating an example of a mobile device according to a second embodiment.

FIG. 24 is a flowchart illustrating a photographing and evaluation method according to the second embodiment.

FIG. 25 is a diagram for describing an example of an excavation amount calculation method according to the second embodiment.

FIG. 26 is a diagram schematically illustrating an example of an excavator having a detection device for detecting an operation of a bucket.

FIG. 27 is a diagram for describing an example of a method for remote control of an excavator.

FIG. 28 is a diagram for describing an example of a method for remote control of an excavator.

### DESCRIPTION OF EMBODIMENTS

While embodiments of the present invention will be described with reference to the drawings, the present invention is not limited to these embodiments. The constituent elements of respective embodiments described later can be appropriately combined with each other. Moreover, some of the constituent elements may not be used.

### First Embodiment

<Evaluation System>

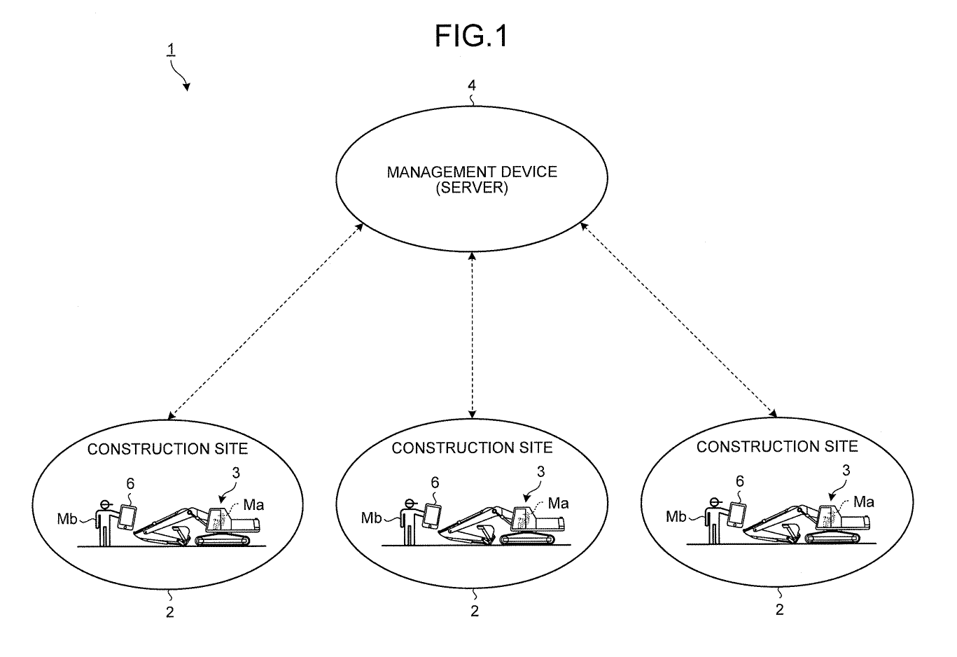

FIG. 1 is a diagram schematically illustrating an example of an evaluation system 1 according to the present embodiment. A working vehicle 3 operates in a construction site 2. The working vehicle 3 is operated by an operator Ma boarding on the working vehicle 3. The evaluation system 1 evaluates one or both of the operation of the working vehicle 3 and the skill of the operator Ma operating the working vehicle 3. The operator Ma operates the working vehicle 3 to perform a construction operation in the construction site 2. In the construction site 2, a worker Mb other than the operator Ma performs construction work. The worker Mb performs assistance work in the construction site 2, for example. For example, the worker Mb uses a mobile device 6.

The evaluation system 1 includes a management device 4 including a computer system and the mobile device 6 including a computer system. The management device 4 functions as a server. The management device 4 provides a service to a client. The client includes at least one of the operator Ma, the worker Mb, an owner of the working vehicle 3, and a person who rents the working vehicle 3. The owner of the working vehicle 3 may be the same person as or a person different from the operator Ma of the working vehicle 3.

The mobile device 6 is possessed by at least one of the operator Ma and the worker Mb. Examples of the mobile device 6 include a portable computer such as a smartphone or a tablet personal computer.

The management device 4 can perform data communication with a plurality of mobile devices 6.

<Working Vehicle>

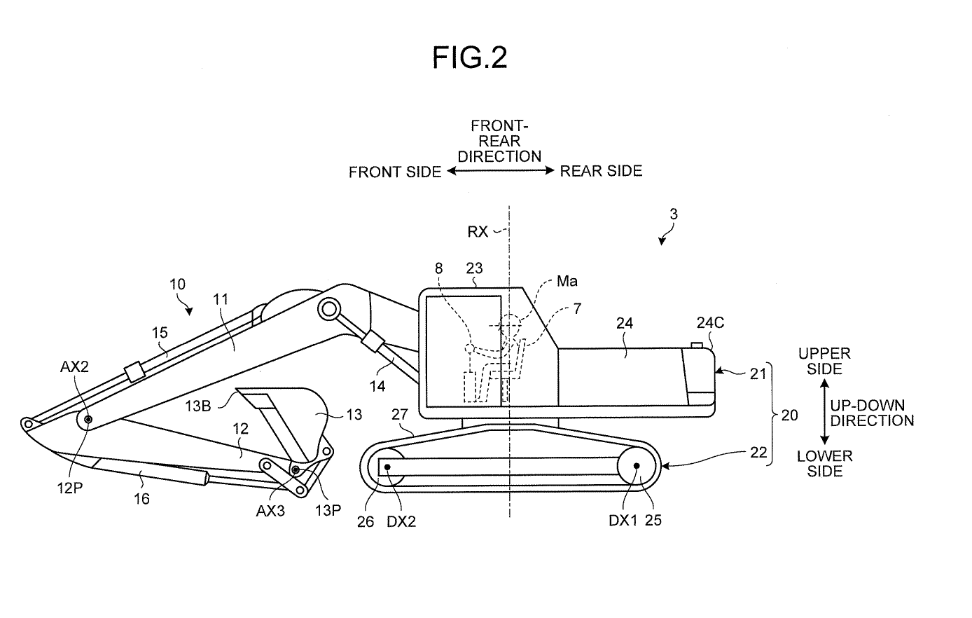

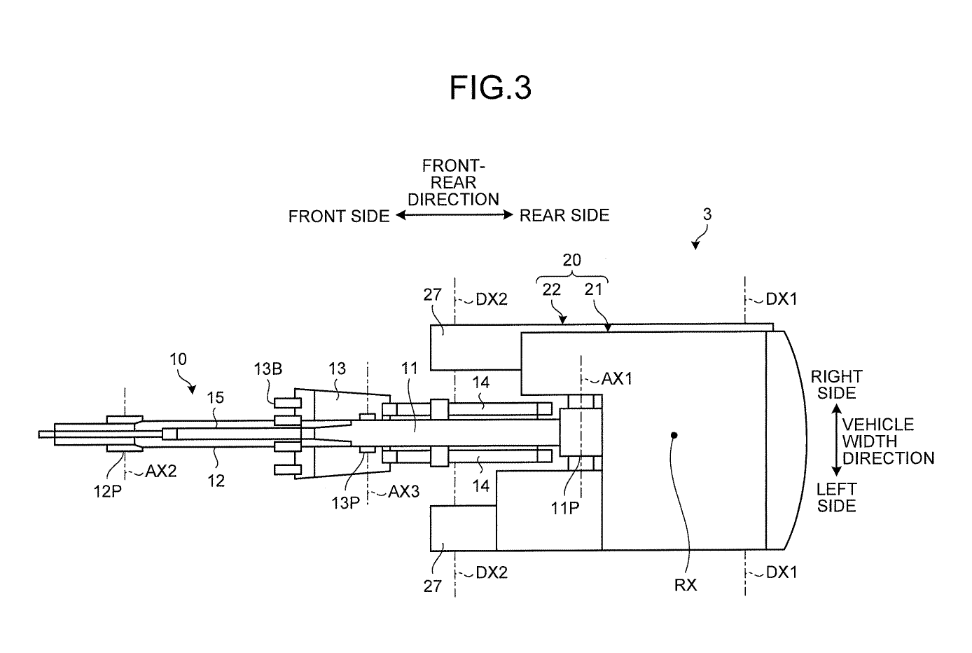

Next, the working vehicle 3 according to the present embodiment will be described. In the present embodiment, an example in which the working vehicle 3 is an excavator will be described. FIG. 2 is a side view illustrating an example of the excavator 3 according to the present embodiment. FIG. 3 is a plan view illustrating an example of the excavator 3 according to the present embodiment. FIG. 3 illustrates a plan view when the excavator 3 is seen from above in an attitude of a working unit 10 illustrated in FIG. 2.

As illustrated in FIGS. 2 and 3, the excavator 3 includes the working unit 10 that operates with hydraulic pressure and a vehicle body 20 that supports the working unit 10. The vehicle body 20 includes an upper swing structure 21 and a lower traveling body 22 that supports the upper swing structure 21.

The upper swing structure 21 includes a cab 23, a machine room 24, and a counterweight 24C. The cab 23 includes a cabin. A driver's seat 7 on which the operator Ma sits and an operating device 8 operated by the operator Ma are disposed in the cabin. The operating device 8 includes a working lever for operating the working unit 10 and the upper swing structure 21 and a travel lever for operating the lower traveling body 22. The working unit 10 is operated by the operator Ma with the aid of the operating device 8. The upper swing structure 21 and the lower traveling body 22 are operated by the operator Ma with the aid of the operating device 8. The operator Ma can operate the operating device 8 in a state of sitting on the driver's seat 7.

The lower traveling body 22 includes a drive wheel 25 called a sprocket, an idler wheel 26 called an idler, and a crawler belt 27 supported by the drive wheel 25 and the idler wheel 26. The drive wheel 25 operates with power generated by a drive source such as a hydraulic motor, for example. The drive wheel 25 rotates according to an operation of the travel lever of the operating device 8. The drive wheel 25 rotates about a rotation axis DX1. The idler wheel 26 rotates about a rotation axis DX2. The rotation axes DX1 and DX2 are parallel to each other. When the drive wheel 25 rotates and the crawler belt 27 rotates, the excavator 3 travels or swings back and forth.

The upper swing structure 21 can swing about a swing axis RX in a state of being supported by the lower traveling body 22.

The working unit 10 is supported by the upper swing structure 21 of the vehicle body 20. The working unit 10 includes a boom 11 connected to the upper swing structure 21, an arm 12 connected to the boom 11, a bucket 13 connected to the arm 12. The bucket 13 has a plurality of convex teeth, for example. The bucket 13 has a plurality of cutting edges 13B which are distal ends of the teeth. The cutting edges 13B of the bucket 13 may be the distal ends of straight teeth formed in the bucket 13.

As illustrated in FIG. 3, the upper swing structure 21 and the boom 11 are connected by a boom pin 11P. The boom 11 is supported by the upper swing structure 21 so as to be operable using a rotation axis AX1 as a support point. The boom 11 and the arm 12 are connected by an arm pin 12P. The arm 12 is supported by the boom 11 so as to be operable using a rotation axis AX2 as a support point. The arm 12 and the bucket 13 are connected by a bucket pin 13P. The bucket 13 is supported by the arm 12 so as to be operable using a rotation axis AX3 as a support point. The rotation axes AX1, AX2, and AX3 are parallel to each other in a front-rear direction. The definition of the front-rear direction will be described later.

In the following description, the extension direction of the rotation axes AX1, AX2, and AX3 will be appropriately referred to a vehicle width direction of the upper swing structure 21, the extension direction of the swing axis RX will be appropriately referred to an up-down direction of the upper swing structure 21, and a direction orthogonal to both the rotation axes AX1, AX2, and AX3 and the swing axis RX will be appropriately referred to as a front-rear direction of the upper swing structure 21.

In the present embodiment, when the operator Ma sitting on the driver's seat 7 is taken as a reference, a direction in which the working unit 10 including the bucket 13 is present is a front side and a side opposite to the front side is a rear side. One side in the vehicle width direction is a right side, and the opposite direction of the right side (that is, the direction in which the cab 23 is present) is a left side. The bucket 13 is disposed closer to the front side than the upper swing structure 21. The plurality of cutting edges 13B of the bucket 13 is arranged in the vehicle width direction. The upper swing structure 21 is disposed above the lower traveling body 22.

The working unit 10 is operated by a hydraulic cylinder. The excavator 3 includes a boom cylinder 14 for operating the boom 11, an arm cylinder 15 for operating the arm 12, and a bucket cylinder 16 for operating the bucket 13. When the boom cylinder 14 extends and retracts, the boom 11 operates using the rotation axis AX1 as a support point and a distal end of the boom 11 moves in the up-down direction. When the arm cylinder 15 extends and retracts, the arm 12 operates using the rotation axis AX2 as a support point and a distal end of the arm 12 moves in the up-down direction or the front-rear direction. When the bucket cylinder 16 extends and retracts, the bucket 13 operates using the rotation axis AX3 as a support point and the cutting edge 13B of the bucket 13 moves in the up-down direction or the front-rear direction. The hydraulic cylinder of the working unit 10 including the boom cylinder 14, the arm cylinder 15, and the bucket cylinder 16 is operated by the working lever of the operating device 8. When the hydraulic cylinder of the working unit 10 extends and retracts, the attitude of the working unit 10 changes.

<Operating Device>

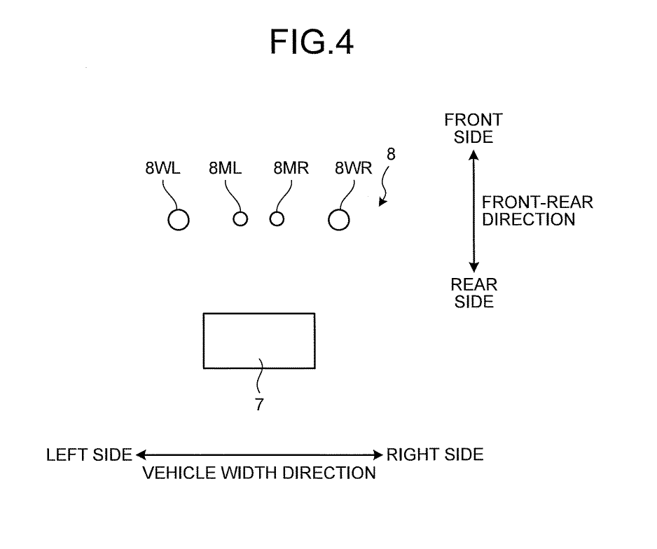

Next, the operating device 8 according to the present embodiment will be described. FIG. 4 is a diagram schematically illustrating an example of the operating device 8 according to the present embodiment. The working lever of the operating device 8 includes a right working lever 8WR disposed closer to the right side than the center of the driver's seat 7 in the vehicle width direction and a left working lever 8WL disposed closer to the left side than the center of the driver's seat 7 in the vehicle width direction. The travel lever of the operating device 8 includes a right travel lever 8MR disposed closer to the right side than the center of the driver's seat 7 in the vehicle width direction and a left travel lever 8ML disposed closer to the left side than the center of the driver's seat 7 in the vehicle width direction.

When the right working lever 8WR at the neural point is inclined toward the front side, the boom 11 performs a lowering operation. When the right working lever 8WR is inclined toward the rear side, the boom 11 performs a raising operation. When the right working lever 8WR at the neural point is inclined toward the right side, the bucket 13 performs a dumping operation. When the right working lever 8WR is inclined toward the left side, the bucket 13 performs a scooping operation.

When the left working lever 8WL at the neural point is inclined toward the right side, the upper swing structure 21 swings toward the right side. When the left working lever 8WL is inclined toward the left side, the upper swing structure 21 swings toward the right side. When the left working lever 8WL at the neural point is inclined toward the lower side, the arm 12 performs a scooping operation. When the left working lever 8WL is inclined toward the upper side, the arm 12 performs an extending operation.

When the right travel lever 8MR at the neural point is inclined toward the front side, a right-side crawler 27 performs a forward moving operation. When the right travel lever 8MR is inclined toward the rear side, the right-side crawler 27 performs a backward moving operation. When the left travel lever 8ML at the neural point is inclined toward the front side, a left-side crawler 27 performs a forward moving operation. When the left travel lever 8ML is inclined toward the rear side, the left-side crawler 27 performs a backward moving operation.

An operation pattern regarding the operation relation between the inclination direction of the right working lever 8WR and the left working lever 8WL and the operation direction of the working unit 10 and the swing direction of the upper swing structure pair 21 may be different from the above-described relation.

<Hardware Configuration>

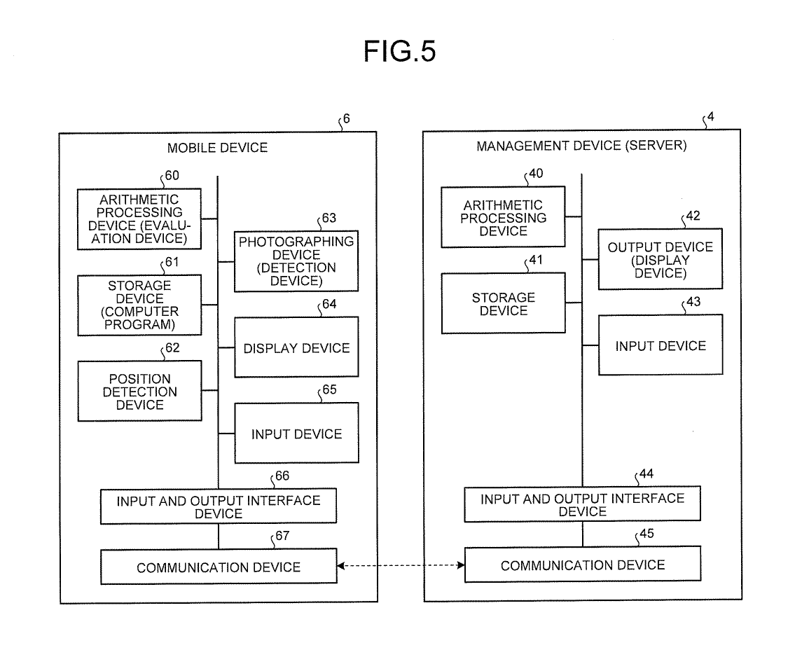

Next, a hardware configuration of the evaluation system 1 according to the present embodiment will be described. FIG. 5 is a diagram schematically illustrating an example of the hardware configuration of the evaluation system 1 according to the present embodiment.

The mobile device 6 includes a computer system. The mobile device 6 includes an arithmetic processing device 60, a storage device 61, a position detection device 62 that detects the position of the mobile device 6, a photographing device 63, a display device 64, an input device 65, an input and output interface device 66, and a communication device 67.

The arithmetic processing device 60 includes a microprocessor such as a central processing unit (CPU). The storage device 61 includes memory such as read-only memory (ROM) or random access memory (RAM) and a storage. The arithmetic processing device 60 performs an arithmetic process according to a computer program stored in the storage device 61.

The position detection device 62 detects an absolute position indicating the position of the mobile device 6 in a global coordinate system with the aid of a global navigation satellite system (GLASS).

The photographing device 63 has a video camera function capable of acquiring video data of a subject and a still camera function capable of acquiring still-image data of a subject. The photographing device 63 includes an optical system and an imaging element that acquires photographic data of a subject via the optical system. The imaging element includes a charge coupled device (CCD) image sensor or a complementary metal oxide semiconductor (CMOS) image sensor.

The photographing device 63 can photograph the excavator 3. The photographing device 63 functions as a detection device that detects the operation of the working unit 10 of the excavator 3. The photographing device 63 photographs the excavator 3 from the outside of the excavator 3 to detect the operation of the working unit 10. The photographing device 63 can acquire the photographic data of the working unit 10 to acquire movement data of the working unit 10 including at least one of a movement trajectory, a moving speed, and a moving time of the working unit 10. The photographic data of the working unit 10 includes one or both of the video data and the still-image data of the working unit 10.

The display device 64 includes a flat panel display such as a liquid crystal display (LCD) or an organic electroluminescence (EL) display (OLED). The input device 65 generates input data when it is operated. In the present embodiment, the input device 65 includes a touch sensor provided on a display screen of the display device 64. The display device 64 includes a touch panel.

The input and output interface device 66 performs data communication with the arithmetic processing device 60, the storage device 61, the position detection device 62, the photographing device 63, the display device 64, the input device 65, and the communication device 67.

The communication device 67 performs wireless data communication with the management device 4. The communication device 67 performs data communication with the management device 4 using a satellite communication network, a cellular communication network, or an Internet line. The communication device 67 may perform data communication with the management device 4 via cables.

The management device 4 includes a computer system. The management device 4 uses a server, for example. The management device 4 includes an arithmetic processing device 40, a storage device 41, an output device 42, an input device 43, an input and output interface device 44, and a communication device 45.

The arithmetic processing device 40 includes a microprocessor such as a CPU. The storage device 41 includes a memory such as ROM or RAM and a storage.

The output device 42 includes a display device such as a flat panel display. The output device 42 may include a printing device that outputs print data. The input device 43 generates input data when it is operated. The input device 43 includes at least one of a keyboard and a mouse. The input device 43 may include a touch sensor provided on a display screen of a display device.

The input and output interface device 44 performs data communication with the arithmetic processing device 40, the storage device 41, the output device 42, the input device 43, and the communication device 45.

The communication device 45 performs wireless data communication with the mobile device 6. The communication device 45 performs data communication with the mobile device 6 using a cellular communication network or an Internet line. The communication device 45 may perform data communication with the mobile device 6 via cables.

<Mobile Device>

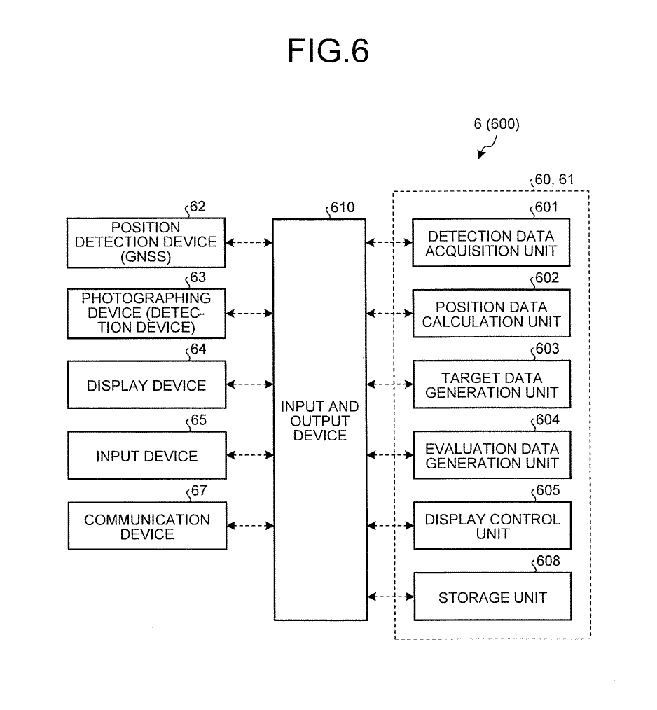

Next, the mobile device 6 illustrated in FIG. 5 will be described in detail. FIG. 6 is a functional block diagram illustrating an example of the mobile device 6 according to the present embodiment. The mobile device 6 functions as an evaluation device 600 that evaluates one or both of the operation of the excavator 3 and the skill of the operator Ma operating the excavator 3. The function of the evaluation device 600 is performed by the arithmetic processing device 60 and the storage device 61.

The evaluation device 600 includes a detection data acquisition unit 601 that acquires detection data including a moving state of the working unit 10 based on photographic data (hereinafter appropriately referred to operation data) of the working unit 10 of the excavator 3, detected by the photographing device 63, a position data calculation unit 602 that calculates position data of the working unit 10 based on the operation data of the working unit 10 of the excavator 3, detected by the photographing device 63, a target data generation unit 603 that generates target data including a target movement condition of the working unit 10, an evaluation data generation unit 604 that generates evaluation data based on the detection data and the target data, a display control unit 605 that controls the display device 64, a storage unit 608, and an input and output unit 610. The evaluation device 600 performs data communication via the input and output unit 610.

The photographing device 63 detects operation data of the working unit 10 operated by the operator Ma using the operating device 8 when the working unit 10 moves from a movement starting position to a movement ending position. In the present embodiment, the operation data of the working unit 10 includes photographic data of the working unit 10 photographed by the photographing device 63.

The detection data acquisition unit 601 acquires detection data including a detected movement trajectory of a predetermined portion of the working unit 10 based on the operation data of the working unit 10 from the movement starting position to the movement ending position of the working unit 10, detected by the photographing device 63. Moreover, the detection data acquisition unit 601 acquires the time elapsed from the start of movement of the bucket 13 based on the photographic data.

The position data acquisition unit 602 calculates the position data of the working unit 10 from the operation data of the working unit 10, detected by the photographing device 63. The position data acquisition unit 602 calculates the position data of the working unit 10 from the photographic data of the working unit 10 using a pattern matching method, for example.

The target data generation unit 603 generates target data including a target movement trajectory of the working unit 10 from the operation data of the working unit 10, detected by the photographing device 63. The details of the target data will be described later.

The evaluation data generation unit 604 generates evaluation data based on the detection data acquired by the detection data acquisition unit 601 and the target data generated by the target data generation unit 603. The evaluation data includes one or both of the evaluation data indicating evaluation results of the operation of the working unit 10 and evaluation results of the operator Ma who operated the working unit 10 using the operating device 8. The details of the evaluation data will be described later.

The display control unit 605 generates display data from the detection data and the target data and displays the display data on the display device 64. Moreover, the display control unit 605 generates display data from the evaluation data and displays the display data on the display device 64. The details of the display data will be described later.

The storage unit 608 stores various types of data. Moreover, the storage unit 608 stores a computer program for implementing an evaluation method according to the present embodiment.

<Evaluation Method>

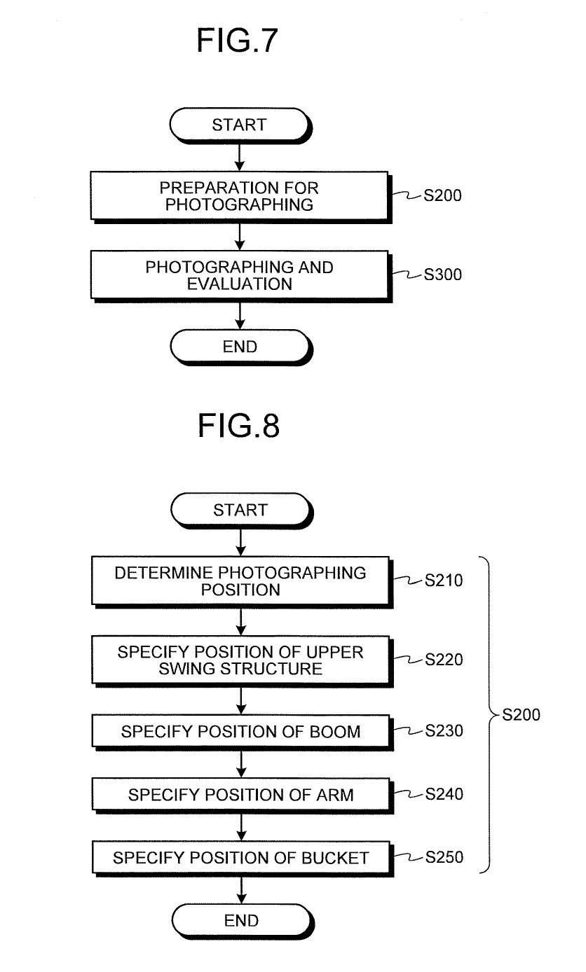

Next, an evaluation method of the operator Ma according to the present embodiment will be described. FIG. 7 is a flowchart illustrating an example of the evaluation method according to the present embodiment.

In the present embodiment, the evaluation method includes a step (S200) of making preparations for photographing the excavator 3 using the photographing device 63 and a step (S300) of photographing the excavator 3 using the photographing device 63 and evaluating the skill of the operator Ma.

(Photographing Preparation)

Preparations for photographing the excavator 3 using the photographing device 63 are made (S200). FIG. 8 is a flowchart illustrating an example of a method of making preparations for photographing according to the present embodiment.

In the present embodiment, the photographing preparation method includes a step (S210) of determining a photographing position of the photographing device 63 in relation to the excavator 3, a step (S220) of specifying the position of the upper swing structure 21, a step (S230) of specifying the position of the boom 11, a step (S240) of specifying the position of the arm 12, and a step (S250) of specifying the position of the bucket 13.

In order to photograph the excavator 3 under constant conditions, a process of determining a relative position of the excavator 3 in relation to the photographing device 63 that photographs the excavator 3 (step S210).

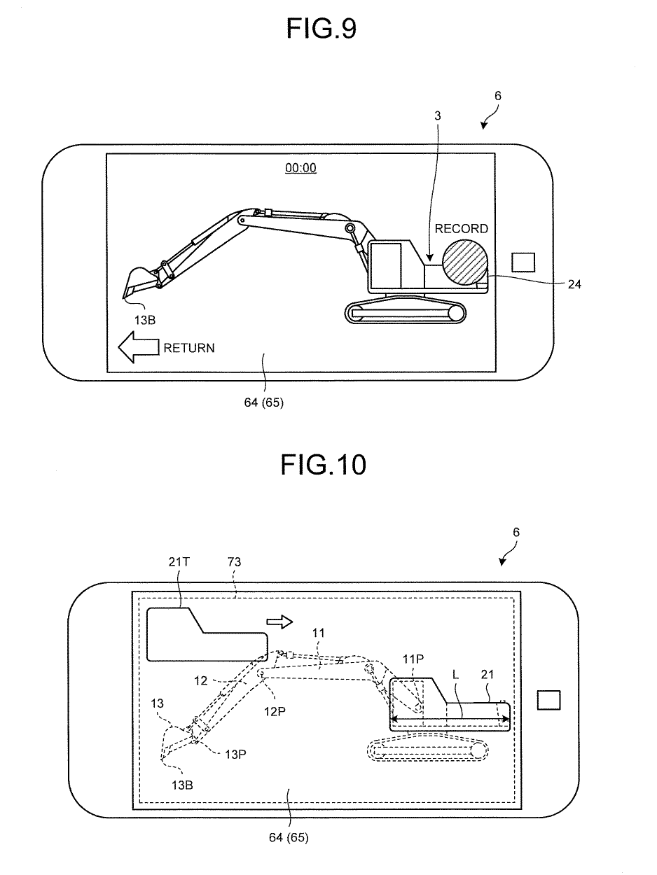

FIG. 9 is a diagram for describing an example of a photographing method according to the present embodiment. When the input device 65 of the mobile device 6 is operated by the operator Ma or the worker Mb, the computer program stored in the storage unit 608 is activated. When the computer program is activated, the mobile device 6 enters a photographing preparation mode. In the photographing preparation mode, the zoom function of the optical system of the photographing device 63 is disabled. The excavator 3 is photographed by the photographing device 63 having a fixed prescribed magnification.

For example, when the worker Mb holds the mobile device 6, determines a photographing position outside the excavator 3, and enters a process starting operation using the input device 65, a process of specifying the position of the upper swing structure 21 is performed (step S220). The position data calculation unit 602 specifies the position of the upper swing structure 21 using a pattern matching method.

FIG. 10 is a diagram for describing a method of specifying the position of the upper swing structure 21 according to the present embodiment. As illustrated in FIG. 10, the photographing device 63 acquires photographic data of a photographing region 73 including the excavator 3. The position data calculation unit 602 calculates the position data of the working unit 10 based on the photographic data of the photographing region 73 photographed by the photographing device 63. The position data calculation unit 602 scans (moves) an upper swing structure template 21T (first template) which is a template of the upper swing structure 21 in relation to the photographing region 73 in the display screen of the display device 64 to calculate the position data of the vehicle body 20. The upper swing structure template 21T is data indicating the shape of the upper swing structure 21 when seen from the left side and is data indicating the shape including the cab 23, the machine room 24, and the counterweight 24C and is stored in the storage unit 608 in advance. The position data calculation unit 602 calculates the position data of the vehicle body 20 based on a correlation value between the upper swing structure template 21T and the photographic data of the vehicle body 20. Here, if the upper swing structure template 21T is data indicating the shape of the cab 23 only or the machine room 24 only, the shape may be similar to a quadrangle and may be more likely to be found in the nature. Thus, it may be difficult to specify the position of the upper swing structure pair 21 based on the photographic data. When the upper swing structure template 21T is data indicating the shape including the cab 23 and at least the machine room 24, the shape may be an L-shaped polygon and may be less likely to be found in the nature. Thus, it becomes easy to specify the position of the upper swing structure pair 21 based on the photographic data.

When the position data of the vehicle body 20 is calculated, the position of the upper swing structure 21 is specified. When the position of the upper swing structure 21 is specified, the position of the boom pin 11P is specified.

Moreover, the position data calculation unit 602 calculates dimension data indicating the dimension of the vehicle body 20 based on the photographic data of the photographing region 73. In the present embodiment, the position data calculation unit 602 calculates the dimension (the dimension L in the front-rear direction) of the upper swing structure 21 on the display screen of the display device 64 when the upper swing structure 21 is seen from the left side.

After the position data of the upper swing structure 21 is calculated, a process of specifying the position of the boom 11 is performed (step S230). The position data calculation unit 602 moves a boom template 11T (second template) which is a template of the boom 11 in relation to the photographing region 73 in the display screen of the display device 64 to calculate the position data of the boom 11. The boom template 11T is data indicating the shape of the boom 11 and is stored in the storage unit 608 in advance. The position data calculation unit 602 calculates the position data of the boom 11 based on a correlation value between the boom template 11T and the photographic data of the boom 11.

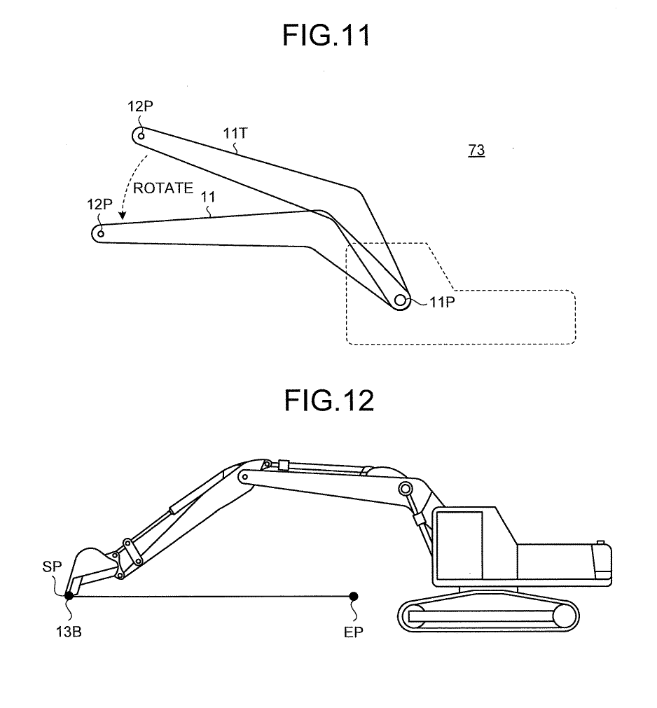

FIG. 11 is a diagram for describing a method of specifying the position of the boom 11 according to the present embodiment. The boom 11 can operate in relation to the upper swing structure 21 using the rotation axis AX1 as a support point. Due to this, since the boom 11 can rotate using the rotation axis AX1 as a support point to take various attitudes, there is a possibility that the photographic data of the boom 11 does not match the prepared boom template 11T depending on the rotation angle of the boom 11 when the boom template 11T is just scanned (moved) in relation to the photographing region 73.

As described above, when the position of the upper swing structure 21 is specified, the position of the boom pin 11P is specified. In the present embodiment, as illustrated in FIG. 11, the position data calculation unit 602 adjusts the position of the boom pin 11P of the boom 11 specified in step S230 and the position of the boom pin of the boom template 11T so as to match each other in the display screen of the display device 64. After the position of the boom pin 11P of the boom 11 and the position of the boom pin of the boom template 11T are adjusted to match each other, the position data calculation unit 602 rotates (moves) the boom template 11T so that the boom 11 indicated by the photographic data matches the boom template 11T in the display screen of the display device 64 to calculate the position data of the boom 11. The position data calculation unit 602 calculates the position data of the boom 11 based on a correlation value between the boom template 11T and the photographic data of the boom 11. Here, various boom templates 11T for various attitudes may be stored in the storage unit 608 in advance, and the position data calculation unit 602 may search the boom templates 11T matching the boom 11 indicated by the photographic data to select any one of the boom templates 11T to calculate the position data of the boom 11.

When the position data of the boom 11 is calculated, the position of the boom 11 is specified. When the position of the boom 11 is specified, the position of the arm pin 12P is specified.

After the position of the boom 11 is calculated, a process of specifying the position of the arm 12 is performed (step S240). The position data calculation unit 602 moves an arm template (second template) which is a template of the arm 12 in relation to the photographing region 73 in the display screen of the display device 64 to calculate the position data of the arm 12. The position data calculation unit 602 calculates the position data of the arm 12 based on a correlation value between the arm template and the photographic data of the arm 12.

The arm 12 can operate in relation to the boom 11 using the rotation axis AX2 as a support point. Due to this, since the arm 12 can rotate using the rotation axis AX2 as a support point to take various attitudes, there is a possibility that the photographic data of the arm 12 does not match the prepared arm template depending on the rotation angle of the arm 12 when the arm template is just scanned (moved) in relation to the photographing region 73.

As described above, when the position of the boom 11 is specified, the position of the arm pin 12P is specified. In the present embodiment, the position data calculation unit 602 specifies the position of the arm 12 according to the same procedure as the procedure of specifying the position of the boom 11. The position data calculation unit 602 adjusts the position of the arm pin 12P of the arm 12 specified in step S240 and the position of the arm pin of the arm template so as to match each other in the display screen of the display device 64. After the position of the arm pin 12P of the arm 12 and the position of the arm pin of the arm template are adjusted to match each other, the position data calculation unit 602 rotates (moves) the arm template so that the arm 12 indicated by the photographic data matches the arm template in the display screen of the display device 64 to calculate the position data of the arm 12. The position data calculation unit 602 calculates the position data of the arm 12 based on a correlation value between the arm template and the photographic data of the arm 12. Here, various arm templates for various attitudes may be stored in the storage unit 608 in advance, and the position data calculation unit 602 may search the arm templates matching the arm 12 indicated by the photographic data to select any one of the arm templates to calculate the position data of the arm 12.

When the position data of the arm 12 is calculated, the position of the arm 12 is specified. When the position of the arm 12 is specified, the position of the bucket pin 13P is specified.

After the position of the arm 12 is calculated, a process of specifying the position of the bucket 13 is performed (step S250). The position data calculation unit 602 moves a bucket template (second template) which is a template of the bucket 13 in relation to the photographing region 73 in the display screen of the display device 64 to calculate the position data of the bucket 13. The position data calculation unit 602 calculates the position data of the bucket 13 based on a correlation value between the bucket template and the photographic data of the bucket 13.

The bucket 13 can operate in relation to the arm 12 using the rotation axis AX3 as a support point. Due to this, since the bucket 13 can rotate using the rotation axis AX3 as a support point to take various attitudes, there is a possibility that the present disclosure of the bucket 13 does not match the prepared bucket template depending on the angle of the bucket 13 when the bucket template is just scanned (moved) in relation to the photographing region 73.

As described above, when the position of the arm 12 is specified, the position of the bucket pin 13P is specified. In the present embodiment, the position data calculation unit 602 specifies the position of the bucket 13 in the same procedure as the procedure of specifying the position of the boom 11 and the procedure of specifying the position of the arm 12. The position data calculation unit 602 adjusts the position of the bucket pin 13P of the bucket 13 specified in step S250 and the position of the bucket pin of the bucket template so as to match each other in the display screen of the display device 64. After the position of the bucket pin 13P of the bucket 13 and the position of the bucket pin of the bucket template are adjusted to match each other, the position data calculation unit 602 rotates (moves) the bucket template so that the bucket 13 indicated by the photographic data matches the bucket template in the display screen of the display device 64 to calculate the position data of the bucket 13. The position data calculation unit 602 calculates the position data of the bucket 13 based on a correlation value between the bucket template and the photographic data of the bucket 13. Here, various bucket templates for various attitudes may be stored in the storage unit 608 in advance, and the position data calculation unit 602 may search the bucket templates matching the bucket 13 indicated by the photographic data to select any one of the bucket templates to calculate the position data of the bucket 13.

When the position data of the bucket 13 is calculated, the position of the bucket 13 is specified. When the position of the bucket 13 is specified, the position of the cutting edge 13B of the bucket 13 is specified.

(Photographing and Evaluation)

When the step (S200) of making preparations for photographing the excavator 3 using the photographing device 63 is executed, the position of the working unit 10 is specified, and the movement starting position of the bucket 13, described later is specified, the mobile device 6 enters a photographing and evaluation mode. In the photographing and evaluation mode, the zoom function of the optical system of the photographing device 63 is disabled. The excavator 3 is photographed by the photographing device 63 having a fixed prescribed magnification. The prescribed magnification in the photographing preparation mode is the same as the prescribed magnification in the photographing and evaluation mode.

A moving state of the working unit 10 of the excavator 3 operated by the operator Ma with the aid of the operating device 8 is photographed by the photographing device 63 of the mobile device 6. In the present embodiment, in evaluation of the skill of the operator Ma, the operation condition of the working unit 10 by the operator Ma is determined so that the working unit 10 moves under specific movement conditions.

FIG. 12 is a diagram schematically illustrating the operation condition of the working unit 10 imposed on the operator Ma in the evaluation method according to the present embodiment. In the present embodiment, as illustrated in FIG. 12, as the operation condition of operating the working unit 10, an operation condition that the cutting edge 13B of the bucket 13 in a no-load state in the air is to be operated so as to draw a linear movement trajectory along a horizontal plane is imposed on the operator Ma of the excavator 3. The operator Ma operates the operating device 8 so that the cutting edge 13B of the bucket 13 draws a linear movement trajectory along a horizontal plane.

In the present embodiment, the movement starting position and the movement ending position of the bucket 13 are arbitrarily determined by the operator Ma. In the present embodiment, a position at which a period in which the cutting edge 13B of the bucket 13 is stopped is equal to or longer than a prescribed period and the bucket 13 in the stopped state starts moving is determined as the movement starting position. Moreover, the time at which the bucket 13 in the stopped state starts moving is determined as a movement starting time. Moreover, a position at which it is determined that the cutting edge 13B of the bucket 13 in the moving state stops moving and the stopped period is equal to or longer than a prescribed period is determined as the movement ending position. Moreover, the time at which the bucket 13 stops moving is determined as a movement ending time. In other words, the position at which the bucket 13 in the stopped state starts moving is the movement starting position, and the time at which the bucket 13 starts moving is the movement starting time. The position at which the bucket 13 in the moving state stops moving is the movement ending position and the time at which the bucket 13 stops moving is the movement ending time.

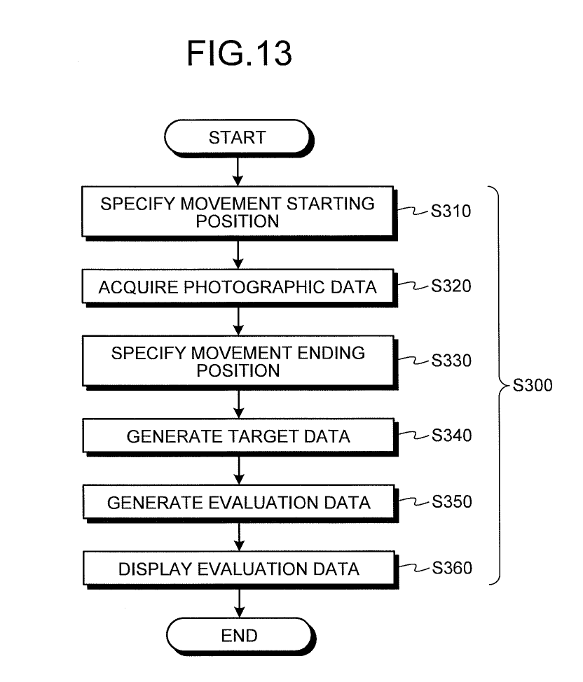

FIG. 13 is a flowchart illustrating an example of a photographing and evaluation method according to the present embodiment. FIG. 13 illustrates the step (S300) of photographing the excavator 3 using the photographing device 63 and evaluating the skill of the operator Ma. The photographing and evaluation method according to the present embodiment includes a step (S310) of specifying the movement starting position of the working unit 10, a step (S320) of acquiring the photographic data of the moving working unit 10, a step (S330) of specifying the movement ending position of the working unit 10, a step (S340) of generating target data of the working unit 10, a step (S350) of generating evaluation data of the operator Ma based on the photographic data and the target data, and a step (S360) of displaying the evaluation data on the display device 64.

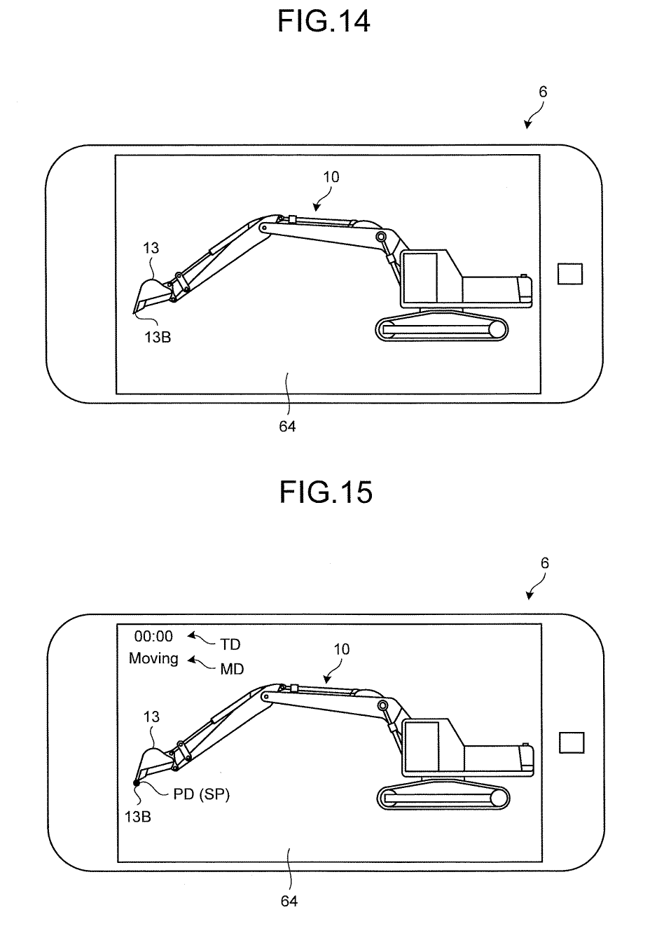

Here, as illustrated in FIG. 9, the worker Mb presses a record button displayed on the display device 64 as an example of the input device 65. The worker Mb photographs the excavator 3 from the outside of the excavator 3. Due to this, a process of specifying the movement starting position and the movement starting time of the bucket 13 of the working unit 10 is performed (step S310). FIG. 14 is a diagram for describing a method of specifying the movement starting position of the working unit 10 according to the present embodiment. The detection data acquisition unit 601 specifies the position of the cutting edge 13B of the bucket 13 of the working unit 10 in the stopped state based on the photographic data of the working unit 10 photographed by the photographing device 63. When it is determined that a period in which the cutting edge 13B of the bucket 13 is stopped is equal to or longer than the prescribed period, the detection data acquisition unit 601 determines the position of the cutting edge 13B of the bucket 13 as the movement starting position of the bucket 13.

When the bucket 13 in the stopped state starts moving according to an operation of the operator Ma, the detection data acquisition unit 601 detects that the movement of the bucket 13 has started based on the photographic data of the working unit 10. The detection data acquisition unit 601 determines the time at which the cutting edge 13B of the bucket 13 in the stopped state starts moving as the movement starting time of the bucket 13.

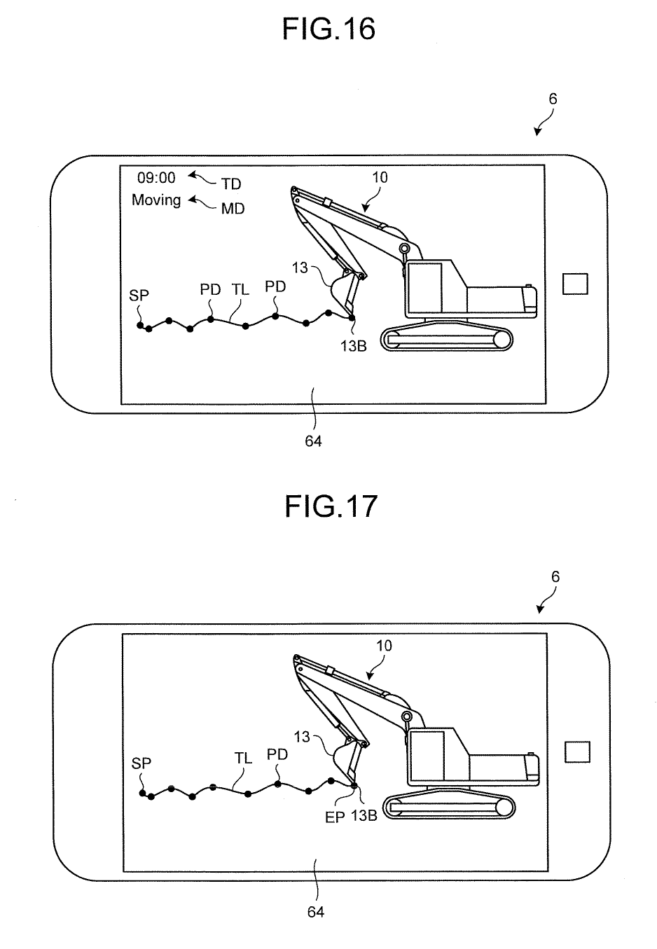

When the movement of the bucket 13 starts, the detection data acquisition unit 601 acquires the photographic data which is the video data of the working unit 10 from the photographing device 63 (step S320). FIGS. 15 and 16 are diagrams for describing a method of acquiring the photographic data of the working unit 10 according to the present embodiment. The detection data acquisition unit 601 starts acquiring the photographic data of the working unit 10 that has started moving.

In the present embodiment, the detection data acquisition unit 601 acquires the detection data including the movement trajectory of the working unit 10 based on the photographic data of the bucket 13 from the movement starting position to the movement ending position. In the present embodiment, the detection data includes the movement trajectory of the working unit 10 in a no-load state in the air in a period after the working unit 10 in the stopped state starts moving at the movement starting position until the working unit 10 ends moving at the movement ending position. The detection data acquisition unit 601 acquires the movement trajectory of the bucket 13 based on the photographic data. Moreover, the detection data acquisition unit 601 acquires the time elapsed from the start of movement of the bucket 13 based on the photographic data.

FIG. 15 illustrates the display device 64 immediately after the movement of the bucket 13 has started. When it is determined by the detection data acquisition unit 601 that the movement of the bucket 13 has started, the position data calculation unit 602 calculates the position data of the cutting edge 13B of the bucket 13 included in the position data of the working unit 10, and the display control unit 605 displays the display data indicating the cutting edge 13B of the bucket 13 on the display device 64. As illustrated in FIG. 15, the movement starting position SP is displayed on the display device 64 as a round point as the display data, for example. The display control unit 605 displays the movement ending position EP on the display device 64 similarly as a round point. In the present embodiment, the display control unit 605 displays a plot PD (SP, EP) which is the display data indicating the cutting edge 13B on the display device 64 as a round point, for example.

Moreover, the display control unit 605 displays the elapsed time data TD which is the display data indicating the time elapsed from the start of movement of the working unit 10 from the movement starting position and character data MD which is the display data indicating that the working unit 10 is moving between the movement starting position and the movement ending position on the display device 64. In the present embodiment, the display control unit 605 displays the character data MD of “Moving” on the display device 64. Due to this, the worker Mb who is a photographer can recognize that the movement of the bucket 13 has started and the acquisition of the movement trajectory of the cutting edge 13B of the bucket 13 has started.

FIG. 16 illustrates the display device 64 when the bucket 13 is moving. The detection data acquisition unit 601 continues detecting the position of the bucket 13 based on the photographic data, and the position data calculation unit 602 continues calculating the position data of the cutting edge 13B of the bucket 13 to detect the detected movement trajectory of the cutting edge 13B of the bucket 13. Moreover, the detection data acquisition unit 601 acquires the elapsed time indicating the moving time of the bucket 13 from the movement starting time.

The display control unit 605 generates display data indicating the detected movement trajectory of the bucket 13 from the detection data to display the display data on the display device 64. The display control unit 605 generates a plot PD indicating the position of the cutting edge 13B of the bucket 13 at fixed time intervals based on the detection data. The display control unit 605 displays the plot PD generated at the fixed time intervals on the display device 64. In FIG. 16, a short interval of the plot PD indicates that the moving speed of the bucket 13 is low, and a long interval of the plot PD indicates that the moving speed of the bucket 13 is high.

Moreover, the display control unit 605 displays a detection line TL indicating the detected movement trajectory of the bucket 13 on the display device 64 based on a plurality of plots PD. The detection line TL is display data of a zigzag shape that connects the plurality of plots PD. The detection line TL may be displayed in such a manner of connecting the plurality of plots PD to form a smooth curve.

When the bucket 13 in the moving state stops moving according to an operation of the operator Ma, a process of specifying the movement ending position and the movement ending time of the bucket 13 of the working unit 10 is performed (step S330). FIG. 17 is a diagram for describing a method of specifying the movement ending position of the working unit 10 according to the present embodiment.

When the bucket 13 in the moving state stops moving according to an operation of the operator Ma, the detection data acquisition unit 601 detects that the movement of the bucket 13 has stopped based on the photographic data. The detection data acquisition unit 601 determines the position at which the cutting edge 13B of the bucket 13 in the moving state stops moving as the movement ending position of the bucket 13. Moreover, the detection data acquisition unit 601 determines the time at which the cutting edge 13B of the bucket 13 in the moving state stops moving as the movement ending time of the bucket 13. When it is determined that the bucket 13 in the moving state stops moving and a period in which the cutting edge 13B of the bucket 13 is stopped is equal to or longer than the prescribed period, the detection data acquisition unit 601 determines the position of the cutting edge 13B of the bucket 13 as the movement ending position of the bucket 13. The position data calculation unit 602 calculates the position data of the cutting edge 13B of the bucket 13 at the movement ending position.

FIG. 17 illustrates the display device 64 immediately after the movement of the bucket 13 is stopped. When it is determined by the detection data acquisition unit 601 that the movement of the bucket 13 has stopped, the display control unit 605 removes the elapsed time data TD and the character data MD from the display device 64. Due to this, the worker Mb who is a photographer can recognize that the movement of the bucket 13 has stopped. Here, the character data MD indicating that the movement of the bucket 13 has stopped may be displayed rather than removing the character data MD from the display device 64.

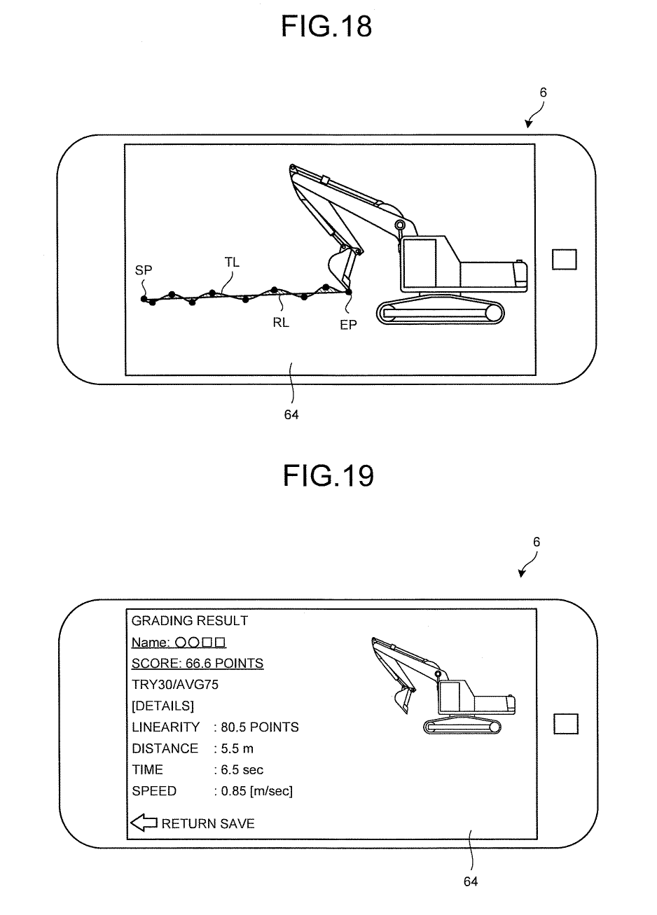

After the movement of the working unit 10 is stopped, a process of generating the target data indicating the target movement trajectory of the working unit 10 is performed (step S340). FIG. 18 is a diagram for describing a method of generating the target data indicating the target movement trajectory of the working unit 10 according to the present embodiment. The target data generation unit 603 generates the target data indicating the target movement trajectory of the bucket 13.

In the present embodiment, the target movement trajectory includes a straight line that connects the movement starting position SP and the movement ending position EP.

As illustrated in FIG. 18, the display control unit 605 generates display data to be displayed on the display device 64 from the target data and displays the display data on the display device 64. In the present embodiment, the display control unit 605 displays a target line RL indicating the target movement trajectory connecting the movement starting position SP and the movement ending position EP on the display device 64. The target line RL is display data of a straight line shape that connects the movement starting position SP and the movement ending position EP. The target line RL is generated based on the target data. That is, the target line RL indicates the target data.

Moreover, the display control unit 605 displays the plot PD (SP, EP) and the detection line TL on the display device 64 together with the target line RL. Due to this, the display control unit 605 generates the display data including the plot PD and the detection line TL from the detection data and generates the display data including the target line RL which is the target data to display the display data on the display device 64.

When the detection line TL and the target line RL are simultaneously displayed on the display device 64, the worker Mb or the operator Ma can qualitatively recognize how much the actual movement trajectory of the bucket 13 (the cutting edge 13B) is away from the target movement trajectory indicated by a straight line.

After the detection data including the movement trajectory is acquired and the target data including the target movement trajectory is generated, a process of generating qualitative evaluation data of the operator Ma based on the detection data and the target data is performed (step S350).

In the present embodiment, the photographic data of the working unit 10 acquired by the photographing device 63 is stored in the storage unit 608. When a plurality of items of photographic data of the working unit 10 is stored in the storage unit 608, the worker Mb selects photographic data to be evaluated among the plurality of items of photographic data stored in the storage unit 608 with the aid of the input device 65. The evaluation data generation unit 604 generates evaluation data from the selected photographic data.

The evaluation data generation unit 604 generates the evaluation data of the operator Ma based on the difference between the movement trajectory and the target movement trajectory. A small difference between the detected movement trajectory and the target movement trajectory means that the operator Ma could move the bucket 13 along the target movement trajectory and is evaluated to have a high skill. On the other hand, a large difference between the detected movement trajectory and the target movement trajectory means that the operator Ma could not move the bucket 13 (the cutting edge 13B) along the target movement trajectory and is evaluated to have a low skill. That is, when the cutting edge 13B is to be moved linearly, it necessary to operate the right working lever 8WR and the left working lever 8WL of the operating device 8 simultaneously or alternately. Thus, when the skill of the operator Ma is low, it is not easy to move the cutting edge 13B linearly and for a long distance in a short period.

In the present embodiment, the evaluation data generation unit 604 generates the evaluation data based on the area of a plane defined by the detection line TL indicating the detected movement trajectory and the target line RL indicating the target movement trajectory. That is, as illustrated in the hatched portions in FIG. 18, the area of a plane DI defined by the detection line TL always indicated by a curve and the target line RL indicated by a straight line is calculated by the evaluation data generation unit 604 and the evaluation data is generated based on the area. The smaller the area, the higher the evaluated skill of the operator Ma, whereas the larger the area, the lower is evaluated the skill of the operator Ma. The size of the area (the plane D1) is also included in the evaluation data.

Moreover, in the present embodiment, the movement starting position SP and the movement ending position EP are specified based on the photographic data. The detection data acquisition unit 601 acquires the distance between the movement starting position SP and the movement ending position EP based on the photographic data. In the present embodiment, the detection data acquired by the detection data acquisition unit 601 includes a moving distance of the bucket 13 between the movement starting position SP and the movement ending position EP.

The evaluation data generation unit 604 generates the evaluation data based on the movement starting position SP and the movement ending position EP. A long distance between the movement starting position SP and the movement ending position EP means that the operator Ma could move the bucket 13 for a long distance along the target movement trajectory and is evaluated to have a high skill. A short distance between the movement starting position SP and the movement ending position EP means that the operator Ma could move the bucket 13 for a short distance along the target movement trajectory and is evaluated to have a low skill.

In the present embodiment, as described with reference to FIG. 10, in the photographing preparation mode, the dimension L of the vehicle body 20 in the front-rear direction in the display screen of the display device 64 is calculated. Moreover, actual dimension data indicating the actual dimension in the front-rear direction of the vehicle body 20 is stored in the storage unit 608. Thus, when the distance between the movement starting position SP and the movement ending position EP in the display screen of the display device 64 is calculated, the detection data acquisition unit 601 can calculate the actual moving distance of the bucket 13 from the movement starting position SP to the movement ending position EP based on a ratio of the dimension L to the actual dimension of the vehicle body 20 stored in the storage unit 608. The moving distance may be calculated by the position data calculation device 602.

Moreover, in the present embodiment, the time elapsed from the start of movement of the bucket 13 and the moving time of the bucket 13 from the movement starting position SP to the movement ending position EP are acquired based on the photographic data. The detection data acquisition unit 601 has an internal timer. The detection data acquisition unit 601 acquires the time between the movement starting time and the movement ending time of the bucket 13 based on the measurement result of the internal timer and the photographic data of the photographing device 63. In the present embodiment, the detection data acquired by the detection data acquisition unit 601 includes the moving time of the bucket 13 between the movement starting time and the movement ending time.

The evaluation data generation unit 604 generates the evaluation data based on the moving time of the bucket 13 (the cutting edge 13B) between the movement starting time and the movement ending time. A short period between the movement starting time and the movement ending time means that the operator Ma could move the bucket 13 along the target movement trajectory in a short period and is evaluated to have a high skill. A long period between the movement starting time and the movement ending time means that the operator Ma took a long period to move the bucket 13 along the target movement trajectory and is evaluated to have a low skill.

Moreover, as described above, the detection data acquisition unit 601 calculates the actual moving distance of the bucket 13 from the movement starting position SP to the movement ending position EP. Thus, the detection data acquisition unit 601 can calculate the moving speed (average moving speed) of the bucket 13 between the movement starting position SP and the movement ending position EP based on the actual moving distance of the bucket 13 from the movement starting position SP to the movement ending position EP and the moving time of the bucket 13 from the movement starting time and the movement ending time. The moving speed may be calculated by the position data calculation device 602. In the present embodiment, the detection data acquired by the detection data acquisition unit 601 includes the moving speed of the bucket 13 between the movement starting position SP and the movement ending position EP.

The evaluation data generation unit 604 generates the evaluation data based on the moving speed of the bucket 13 (the cutting edge 13B) between the movement starting position SP and the movement ending position EP. A high moving speed of the bucket 13 between the movement starting position SP and the movement ending position EP means that the operator Ma could move the bucket 13 (the cutting edge 13B) at a high speed along the target movement trajectory and is evaluated to have a high skill. A low moving speed of the bucket 13 between the movement starting position SP and the movement ending position EP means that the operator Ma could move the bucket 13 (the cutting edge 13B) at a low speed only along the target movement trajectory and is evaluated to have a low skill.

When the evaluation data described above is generated, a process of displaying the evaluation data on the display device 64 is performed (step S360). FIG. 19 is a diagram for describing an evaluation data display method according to the present invention. The display control unit 605 generates display data from the evaluation data and displays the display data on the display device 64.

As illustrated in FIG. 19, the display control unit 605 displays the name of the operator Ma, which is personal data, for example, on the display device 64. The personal data is stored in the storage unit 606 in advance. Moreover, the display control unit 605 displays respective items including “linearity” indicating the difference between the target movement trajectory and the detected movement trajectory, “distance” indicating the moving distance of the bucket 13 from the movement starting position SP to the movement ending position EP, “time” indicating the moving time of the bucket 13 from the movement starting position SP to the movement ending position EP, and “speed” indicating the average moving speed of the bucket 13 from the movement starting position SP to the movement ending position EP on the display device 64 as the evaluation data. Moreover, the display control unit 605 displays numerical data of the respective items of “linearity”, “distance”, “time”, and “speed” on the display device 64 as the qualitative evaluation data. The numerical data of “linearity” can be calculated such that a perfect score of 100 is assigned when the difference (the plane DI) between the target movement trajectory and the detected movement trajectory is smaller than a predetermined amount, and the score decreases as the difference increases from the predetermined amount. As for “distance”, “time”, and “speed”, the numerical data may be displayed on the display device 64 as scores based on the difference from a reference value corresponding to the perfect score of 100.

In the present embodiment, the operation of the cutting edge 13B of the bucket 13, which is the predetermined portion of the working unit 10 was focused on as the operation of the working unit 10, and the movement trajectory of the cutting edge 13B was acquired whereby the evaluation data such as “linearity”, “distance”, “time”, and “speed” of the cutting edge 13 was acquired. However, the operation of another portion (for example, a distal end of the arm or a portion (predetermined portion) other than the cutting edge 13B of the bucket 13) may be focused on as the operation of the working unit 10, for example, and the evaluation data including the “linearity” indicating the difference between the target movement trajectory of the corresponding portion and the detected movement trajectory of the corresponding portion, the “distance” indicating the moving distance of the corresponding portion from the movement starting position SP to the movement ending position EP, the “time” indicating the moving time of the corresponding portion from the movement starting position SP to the movement ending position EP, and the “speed” indicating the average moving speed of the corresponding portion from the movement starting position SP to the movement ending position EP may be acquired. That is, since the photographing device 63 (the detection device) detects the operation of the working unit 10 to acquire the photographic data, the movement trajectory of the predetermined portion of the working unit 10 may be acquired using the operation data based on the movement of the working unit 10 included in the photographic data and the evaluation data may be generated.

Moreover, the display control unit 605 displays the skill score of the operator Ma on the display device 64 as the qualitative evaluation data. Reference data for the skill is stored in the storage unit 608. The reference data is evaluation data obtained by comprehensively evaluating the numerical data of the respective items of “linearity”, “distance”, “time”, and “speed” for an operator having a standard skill, for example, and is obtained statistically or empirically. The skill score of the operator Ma is calculated based on the reference data.

Moreover, the display control unit 605 may display count data indicating how many items of evaluation data the operator Ma generated in the past and an average or highest score of the past evaluation data (skill scores) on the display device 64.

In the present embodiment, the evaluation data generation unit 604 outputs the generated evaluation data to an external server via the communication device 67. The external excavator may be the management device 4 and may be another server other than the management device 4.

After the evaluation data is transmitted to the external server, relative data indicating a relative evaluation result of the operator Ma to other operators Ma is provided from the external server to the communication device 67 of the mobile device 6. The evaluation data generation unit 604 acquires the relative data supplied from the external server. The display control unit 605 generates display data for the relative data and displays the display data on the display device 64.

In the present embodiment, the relative data indicating a relative evaluation result of the operator Ma to other operators Ma includes ranking data obtained by ranking the skills of a plurality of operators Ma. The evaluation data of a plurality of operators Ma present all over the country is collected to the external server. The external server adds and analyzes the evaluation data of the plurality of operators Ma to generate the skill ranking data of each of the plurality of operators Ma. The external server distributes the generated ranking data to the respective mobile devices 6. The ranking data is relative data which is included in the evaluation data and which indicates a relative evaluation result to other operators Ma.

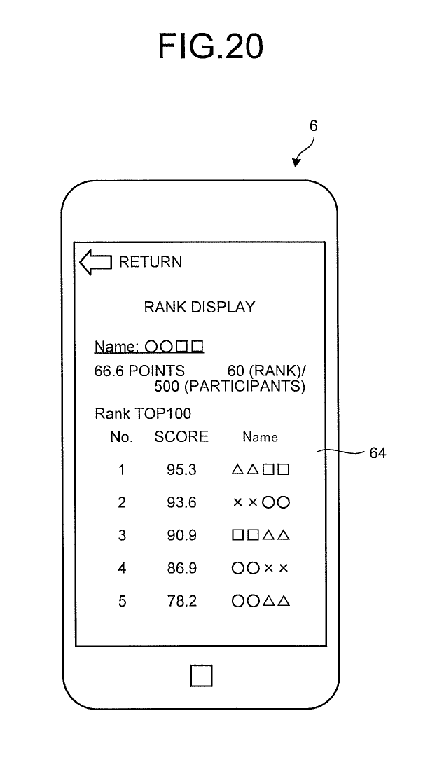

FIG. 20 is a diagram for describing an example of a relative data display method according to the present embodiment. As illustrated in FIG. 20, the display control unit 605 generates display data from the relative data to display the display data on the display device 64. Similarly to the example illustrated in FIG. 22, the display control unit 605 displays the following information on the display data on the display device 64. For example, the name of the operator Ma, the number of operators Ma in the country, who have registered the personal data on the mobile device 6 and generated evaluation data using the mobile device 6, the rank based on the evaluation data (score) of the operator Ma who has generated evaluation data using the mobile device 6 (the mobile device 6 on which the display data is to be displayed) among the operators Ma in the nation, and the score indicating the evaluation data are displayed on the display device 64. Here, information indicating the names and the scores of operators Ma whose scores indicating the evaluation data are on the higher rank may be received from the external server and the display control unit 605 may display the information on the display device 64. The rank based on the evaluation data is relative data which includes the evaluation data and indicates a relative evaluation result in relation to other operators Ma.

<Operations and Effects>

As described above, according to the present embodiment, it is possible to objectively and qualitatively evaluate the skill of the operator Ma of the excavator 3 with the aid of the evaluation device 600 including the detection data acquisition unit 601 that acquires the detection data including the detected movement trajectory of the working unit 10, the target data generation unit 603 that generates the target data including the target movement trajectory of the working unit 10, and the evaluation data generation unit 604 that generates the evaluation data of the operator Ma based on the detection data and the target data. When the evaluation data and the relative data based on the evaluation data are provided to the operator Ma, the operator Ma will be more encouraged to improve the skill. Moreover, the operator Ma can improve his or her operation based on the evaluation data.

Moreover, in the present embodiment, the detection data includes the movement trajectory of the working unit 10 in a no-load state in the air in a period after the working unit 10 in the stopped state starts moving at the movement starting position SP until the working unit 10 ends moving at the movement ending position EP. When the operation condition is imposed on the operator Ma so that the working unit 10 moves in the air, the evaluation conditions for operators Ma present all over the country can be made constant. If the qualities of soil are different depending on the construction site 2, for example, when the operators Ma present all over the country are evaluated based on an actual excavation operation, for example, the skills of the operators Ma will be evaluated under different evaluation conditions. In this case, the evaluations may be unfair. Thus, when the operators Ma are evaluated based on an operation of moving the working unit 10 in the air, the skills of the operators Ma can be evaluated fairly under the same evaluation condition.

Moreover, in the present embodiment, a straight line that connects the movement starting position SP and the movement ending position EP is used as the target movement trajectory. Due to this, the target movement trajectory can be set in a simple manner without requiring a complex process.

Moreover, according to the present embodiment, the evaluation data generation unit 604 generates the evaluation data based on the difference between the detected movement trajectory and the target movement trajectory. Due to this, it is possible to appropriately evaluate the skill of the operator Ma who moves the cutting edge 13B of the bucket 13 straightly. According to the present embodiment, the evaluation data generation unit 604 generates the evaluation data based on the area (difference) of the plane defined by the detection line TL indicating the detected movement trajectory and the target line RL indicating the target movement trajectory. Due to this, it is possible to more appropriately evaluate the skill of the operator Ma who moves the cutting edge 13B of the bucket 13 straightly.

Moreover, according to the present embodiment, the detection data includes the moving distance of the bucket 13 between the movement starting position SP and the movement ending position EP, and the evaluation data generation unit 604 generates the evaluation data based on the moving distance of the bucket 13. Due to this, the operator Ma capable of moving the cutting edge 13B of the bucket 13 for a long distance can be appropriately evaluated as a person having a high skill.

Moreover, according to the present embodiment, the detection data includes the moving time of the bucket 13 from the movement starting position SP to the movement ending position EP, and the evaluation data generation unit 603 generates the evaluation data based on the moving time of the bucket 13. Due to this, the operator Ma capable of moving the cutting edge 13B of the bucket 13 in a short period can be appropriately evaluated as a person having a high skill.

Moreover, according to the present embodiment, the detection device 63 that detects the operation data of the working unit 10 is the photographing device 63 that detects the operation data of the working unit 10. Due to this, it is possible to acquire the operation data of the working unit 10 in a simple manner without using a large-scale device.

Moreover, in the present embodiment, the position data calculation unit 602 scans (moves) the upper swing structure template 21T in relation to the photographing region 73 to calculate the position data of the upper swing structure 21 based on the correlation value between the upper swing structure template 21T (first template) and the photographic data of the upper swing structure 21 and then moves the boom template 11T (second template) in relation to the photographing region 73 to calculate the position data of the boom 11 based on the correlation value between the boom template 11T and the photographic data of the boom 11. Due to this, it is possible to specify the position of the working unit 10 in the excavator 3 having such a characteristic structure or movement that the working unit 10 moving in relation to the vehicle body 20 is present. In the present embodiment, after the position of the upper swing structure 21 including the boom pin 11P is specified by a pattern matching method, the position of the boom 11 is specified based on the boom pin 11P, whereby the position of the boom 11 is specified accurately. The position of the arm 12 is specified based on the arm pin 12P after the position of the boom 11 is specified, and the position of the bucket 13 is specified based on the bucket pin 13P after the position of the arm 12 is specified. Thus, it is possible to accurately specify the position of the cutting edge 13B of the bucket 13 in the excavator 3 having a characteristic structure or movement.

Moreover, according to the present embodiment, the position data calculation unit 602 calculates the dimension data of the upper swing structure 21 in the display screen of the display device 64 based on the photographic data of the photographing region 73. Due to this, the evaluation data generation unit 604 can calculate the actual distance between the movement starting position SP and the movement ending position EP from the ratio of the dimension data of the upper swing structure 21 in the display screen of the display device 64 to the actual dimension data of the upper swing structure 21.

Moreover, according to the present embodiment, the display control unit 605 that generates the display data from the detection data and the target data and displays the display data on the display device 64 is provided. Due to this, the operator Ma can visually and qualitatively recognize how much his or her skill is away from the target. Moreover, since the display data is displayed on the display device 64 as the numerical data such as linearity, distance, time, speed, and score, the operator Ma can recognize his or her skill qualitatively.

Moreover, according to the present embodiment, the display data includes one or both of the elapsed time data TD indicating the time elapsed from the start of movement of the working unit 10 from the movement starting position SP and the character data MD indicating that the working unit 10 is moving between the movement starting position SP and the movement ending position EP. When the elapsed time data TD is displayed, the worker Mb who is a photographer can visually recognize the time elapsed from the start of movement of the working unit 10. When the character data MD is displayed, the worker Mb who is a photographer can visually recognize that the working unit 10 is moving.

Moreover, according to the present embodiment, the display control unit 605 generates the display data from the evaluation data and displays the display data on the display device 64. Due to this, the operator Ma can visually and objectively recognize the evaluation data for his or her skill.

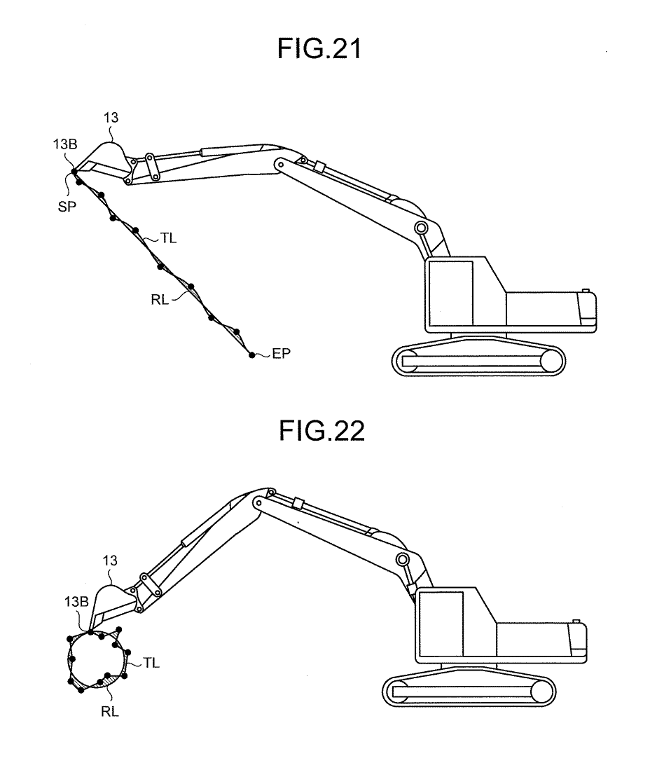

FIGS. 21 and 22 are diagrams for describing an example of a method of evaluating the operator Ma according to the present embodiment. In the above-described embodiment (hereinafter, a first evaluation method), as illustrated in FIG. 12, the operator Ma was caused to operate the working unit 10 so that the cutting edge 13B of the bucket 13 in a no-load state in the air draws a linear movement trajectory along a horizontal plane to evaluate the skill of the operator Ma. An example of such an operation of the working unit 10 as the first evaluation method is a construction operation of shaping a ground surface into a flat surface and a construction operation of spreading and leveling soil. As illustrated in FIG. 21, the operator Ma may be caused to operate the working unit 10 so that the cutting edge 13B of the bucket 13 in a no-load state in the air draws a linear movement trajectory inclined in relation to a horizontal plane to evaluate the skill of the operator Ma (hereinafter, a second evaluation method). An example of such an operation of the working unit 10 as the second evaluation method is a slope finishing construction operation which requires a high skill. As illustrated in FIG. 22, the operator Ma may be caused to operate the working unit 10 so that the cutting edge 13B of the bucket 13 in a no-load state in the air draws a circular movement trajectory to evaluate the skill of the operator Ma (hereinafter, a third evaluation method). When the skill of the operator Ma is evaluate, all of the three first to third evaluation methods may be performed, and any one of the evaluation methods may be performed. Alternatively, when the skill of the operator Ma is evaluated, the three first to third evaluation methods may be performed step by step.

A hoisting operation of hoisting a load using the working unit 10 of the excavator 3 may be performed. The operation data of the working unit 10 during the hoisting operation may be photographed by the photographing device 63, and the skill of the operator Ma may be evaluated based on the operation data.

### Second Embodiment

A second embodiment will be described. In the following description, the same or equivalent portions as those of the above-described embodiment will be denoted by the same reference numerals, and description thereof will be simplified or omitted.

In the embodiment described above, the operator Ma was evaluated based on the moving state of the working unit 10 in a no-load state in the air. In the present embodiment, an example in which the operator Ma is caused to operate the working unit 10 so that the bucket 13 performs an excavation operation to evaluate the operator Ma will be described.

In the present embodiment, in evaluation of the operator Ma, the mobile device 6 having the photographing device 63 is used. The excavation operation of the working unit 10 of the excavator 3 operated by the operator Ma with the aid of the operating device 8 is photographed by the photographing device 63 of the mobile device 6 held by the worker Mb, for example. The photographing device 63 photographs the excavation operation of the working unit 10 from the outside of the excavator 3.

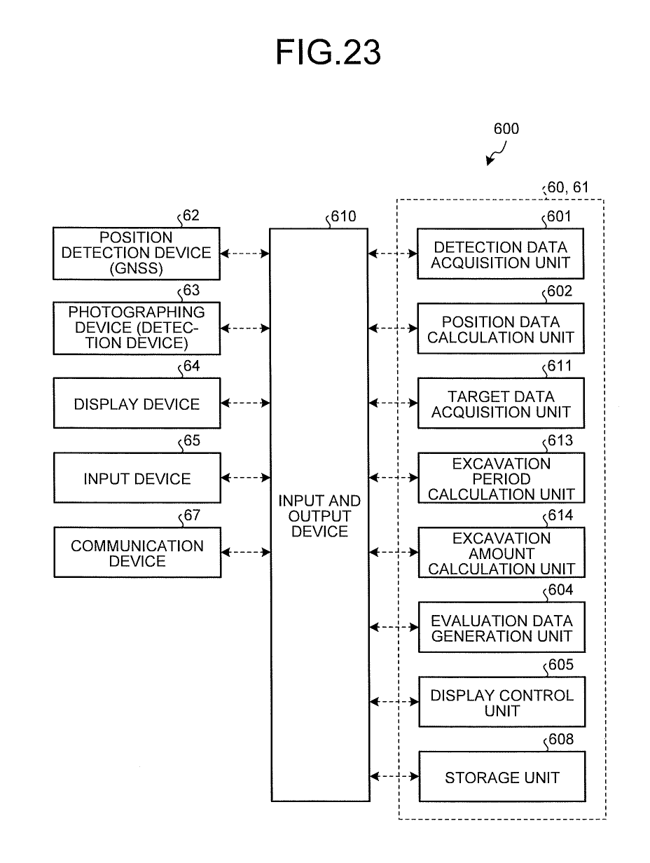

FIG. 23 is a functional block diagram illustrating an example of the mobile device according to the present embodiment. Similarly to the above-described embodiment, the evaluation device 600 includes the detection data acquisition unit 601, the position data calculation unit 602, the evaluation data generation unit 604, the display control unit 605, the storage unit 608, and the input and output unit 610.

In the present embodiment, the detection data acquisition unit 601 performs image processing based on the operation data including the photographic data of the working unit 10 detected by the photographing device 63 to acquire first detection data indicating an excavation amount of the bucket 13 and second detection data indicating an excavation period of the bucket 13. The evaluation data generation unit 604 generates the evaluation data of the operator Ma based on the first detection data and the second detection data.

In the present embodiment, the evaluation device 600 includes an excavation period calculation unit 613 that performs image processing on the photographic data of the bucket 13 photographed by the photographing device 63 to calculate an excavation period of one round of the excavation operation of the bucket 13.

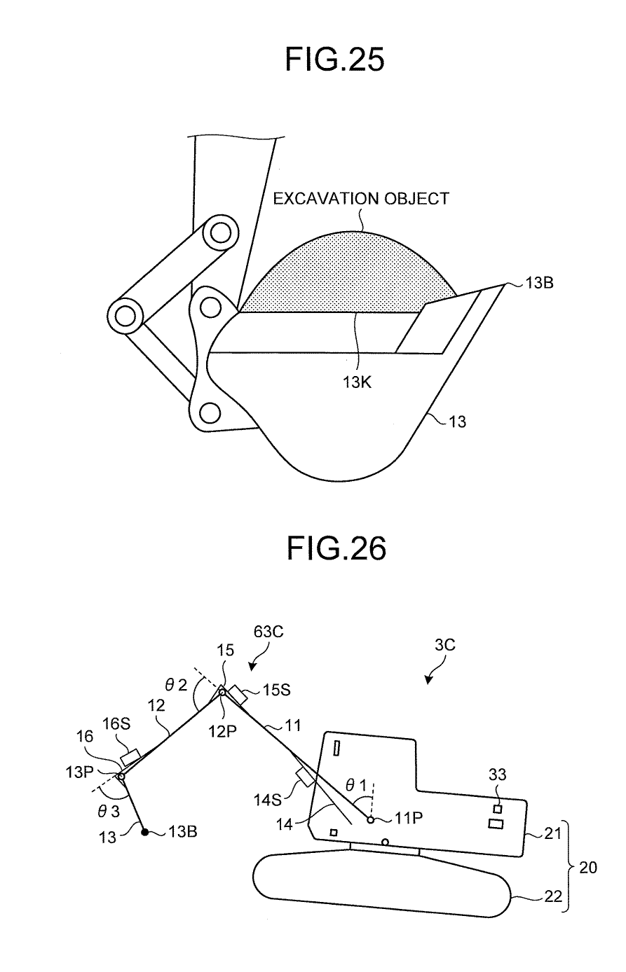

Moreover, the evaluation device 600 includes an excavation amount calculation unit 614 that performs image processing on the photographic data of the bucket 13 photographed by the photographing device 63 to calculate an excavation amount of the bucket 13 from the area of an excavation object protruding from an opening end (an opening end 13K illustrated in FIG. 25) of the bucket 13 when the bucket 13 is seen from a side (the left or right side).

One round of the excavation operation of the bucket 13 is an operation performed until the bucket 13 starts moving to penetrate into the ground surface in order to excavate an excavation object as soil, for example, moves while scooping the soil to hold the soil in the bucket 13, and stops moving. In evaluation of the excavation period required for this operation, the shorter the excavation period, the higher the determined skill of the operator Ma, whereas the longer the excavation period, the lower the determined skill of the operator Ma. The excavation period may be correlated with a score so that evaluation data corresponding to a high score is generated for a short excavation period. On the other hand, in evaluation of the excavation amount, a target excavation amount of the bucket 13 in one round of the excavation operation is designated, and the smaller the difference between the actual excavation amount and the target excavation amount, the higher the determined skill of the operator Ma. The difference may be correlated with a score so that evaluation data corresponding to a high score is generated for a small difference. Alternatively, an overflow rate described later based on an actual excavation amount with respect to a target overflow rate may be generated as the evaluation data. In the present embodiment, the evaluation device 600 includes a target data acquisition unit 611 that acquires target data indicating the target excavation amount of the working unit 10. The evaluation data generation unit 604 generates the evaluation data of the operator Ma based on the difference between the first detection data indicating the excavation amount of the working unit 10 and the target data acquired by the target data acquisition unit 611.

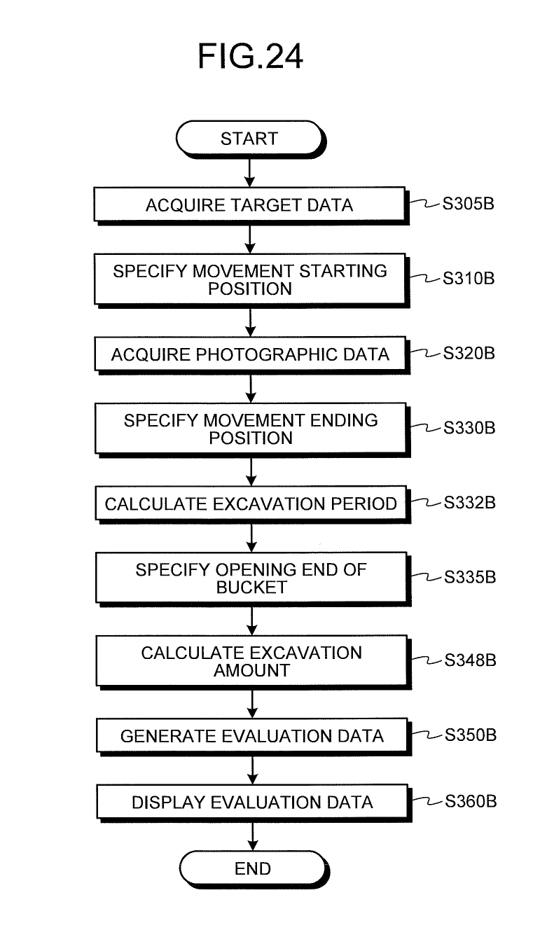

Next, an example of a photographing and evaluation method according to the present embodiment will be described. FIG. 24 is a flowchart illustrating an example of the photographing and evaluation method according to the present embodiment. The photographing and evaluation method according to the present embodiment includes a step (S305B) of acquiring the target data indicating the target excavation amount of the working unit 10, a step (S310B) of specifying the movement starting position of the working unit 10, a step (S320B) of acquiring the photographic data of the moving working unit 10, a step (S330B) of specifying the movement ending position of the working unit 10, a step (S332B) of calculating the excavation period of the bucket 13, a step (S335B) of specifying the opening end of the bucket 13, a step (S348B) of calculating the excavation amount of the bucket 13, a step (S350B) of generating the evaluation data of the operator Ma, and a step (S360B) of displaying the evaluation data on the display device 64.

A process of acquiring the target data indicating the target excavation amount of the working unit 10 is performed (step S305B). The operator Ma declares a target excavation amount that the operator Ma is to excavate and inputs the target excavation amount to the evaluation device 600 via the input device 65. The target data acquisition unit 611 acquires the target data indicating the target excavation amount of the bucket 13. The target excavation amount may be stored in the storage unit 608 in advance and the target excavation amount may be used.

The target excavation amount may be designated as the volume of the excavation object and may be designated as an overflow rate based on a state in which a prescribed volume of an excavation object protrudes from the opening end of the bucket 13. In the present embodiment, it is assumed that the target excavation amount is designated as the overflow rate. The overflow rate is a type of a heaped capacity, and in the present embodiment, a state in which, when an excavation object is heaped up from the opening end (the upper edge) of the bucket 13 with a gradient of 1:1, a predetermined amount (for example, 1.0 [m³]) of excavation object is scooped up into the bucket 13 is defined as an overflow rate of 1.0, for example.

Next, a process of specifying the movement starting position and the movement starting time of the bucket 13 of the working unit 10 is performed (step S310B). When it is determined that the stopped period of the bucket 13 is equal to or longer than a prescribed period based on the photographic data of the photographing device 63, the position data calculation unit 602 determines the position of the bucket 13 as the movement starting position of the bucket 13.

When the bucket 13 in the stopped state starts moving according to an operation of the operator Ma, the position data calculation unit 602 detects the movement of the bucket 13 has started based on the photographic data. The position data calculation unit 602 determines the time at which the bucket 13 in the stopped state starts moving as the movement starting time of the bucket 13.

When the movement of the bucket 13 starts, a process of acquiring the operation data of the bucket 13 is performed (step S320B). The operation data of the bucket 13 includes the photographic data of the bucket 13 photographed until the working unit 10 in the stopped state starts moving at the movement starting position to perform an excavation operation, ends the excavation operation, and stops moving at the movement ending position.

When the bucket 13 in the moving state stops moving according to an operation of the operator Ma, a process of specifying the movement ending position and the movement ending time of the bucket 13 of the working unit 10 is performed (step S330B).

When the bucket 13 in the moving state stops moving according to an operation of the operator Ma, the position data calculation unit 602 detects that the movement of the bucket 13 has stopped based on the photographic data. The position data calculation unit 602 determines the position at which the bucket 13 in the moving state stops movement as the movement ending position of the bucket 13. Moreover, the position data calculation unit 602 determines the time at which the bucket 13 in the moving state stops moving as the movement ending time of the bucket 13. When it is determined that the bucket 13 in the moving state stops movement and the stopped period of the bucket 13 is equal to or longer than the prescribed period, the position data calculation unit 602 determines the position of the bucket 13 as the movement ending position of the bucket 13.

The excavation period calculation unit 613 calculates the excavation period of the bucket 13 based on the photographic data (step S332B). The excavation period is a period between the movement starting time and the movement ending time.

Subsequently, the excavation amount calculation unit 614 specifies the opening end 13K of the bucket 13 based on the photographic data of the bucket 13 photographed by the photographing device 63.

FIG. 25 is a diagram for describing an example of an excavation amount calculation method according to the present embodiment. As illustrated in FIG. 25, when the excavation operation ends, an excavation object is scooped up into the bucket 13. In the present embodiment, in evaluation of the operator Ma, for example, an excavation operation is performed so that an excavation object protrudes upward from the opening end 13K of the bucket 13. The excavation amount calculation unit 614 performs image processing on the photographic data of the bucket 13 photographed from the left side by the photographing device 63 and specifies the opening end 13K of the bucket 13, which is the boundary between the bucket 13 and the excavation object. The excavation amount calculation unit 614 can specify the opening end 13K of the bucket 13 based on contrast data including at least one of a luminance difference, a brightness difference, and a chromaticity difference between the bucket 13 and the excavation object.

The excavation amount calculation unit 614 specifies the position of the opening end 13K of the bucket 13, performs image processing on the photographic data of the bucket 13 and the excavation object photographed by the photographing device 63, and calculates the area of the excavation object protruding from the opening end 13K of the bucket 13.

The excavation amount calculation unit 614 calculates the excavation amount of the bucket 13 from the area of the excavation object protruding from the opening end 13K. An approximate amount of soil (excavation amount) excavated by the bucket 13 in one round of the excavation operation is estimated from the area of the excavation object protruding from the opening end 13K. That is, the capacity [m³] of the used bucket 13 and the dimension in the width direction of the bucket 13 are known, and are stored in the storage unit 608 in advance, for example. Thus, the excavation amount calculation unit 614 can calculate the approximate amount of soil (excavation amount) excavated by the bucket 13 in one round of the excavation operation using the amount of soil [m³] corresponding to the area of the excavation object protruding from the opening end 13K, calculated based on the capacity and the width dimension of the bucket 13 and the area of the excavation object protruding from the opening end 13K. The evaluation data described later can be generated based on the calculated excavation amount. The evaluation data described later may be generated using the amount of soil [m³] only corresponding to the area of the excavation object protruding from the opening end 13K.

The evaluation data generation unit 604 generates the evaluation data of the operator Ma based on the first detection data indicating the excavation amount of the bucket 13 calculated in step S348B and the second detection data indicating the excavation period of the bucket 13 calculated in step S332B. The evaluation data may be evaluation data for the excavation amount only and may be evaluation data for the excavation period only. However, since an operator Ma having a high skill in the excavation operation can excavate an appropriate excavation amount with the bucket 13 in a short period in one round of the excavation operation, in order to qualitatively evaluate the skill of the operator Ma, it is preferable to generation the evaluation data using both the excavation amount and the excavation period. That is, for example, the evaluation data generation unit 604 sums up the score for the excavation amount and the score for the excavation period to generate a comprehensive evaluation score.

The evaluation data generation unit 604 generates the evaluation data of the operator Ma based on the difference between the first detection data indicating the excavation amount of the bucket 13 and the target data indicating the target excavation amount of the bucket 13 acquired in step S305B. The smaller the difference between the first detection data and the target data, the superior the evaluated skill of the operator Ma. On the other hand, the larger the difference between the first detection data and the target data, the inferior the evaluate skill of the operator Ma. Moreover, the shorter the excavation period, the higher the determined skill of the operator Ma, whereas the longer the excavation period, the lower the determined skill of the operator Ma.

After the evaluation data is generated, a process of displaying the evaluation data on the display device 64 is performed (step S360B). For example, a score indicating the evaluation data is displayed on the display device 64.

As described above, according to the present embodiment, the operator Ma is caused to perform the excavation operation actually for evaluation of the operator Ma, the first detection data indicating the excavation amount and the second detection data indicating the excavation period of the working unit 10 are acquired, and the evaluation data of the operator Ma is generated based on the first detection data and the second detection data. Thus, it is possible to qualitatively evaluate the skill of the actual excavation operation of the operator Ma.

Moreover, according to the present embodiment, the evaluation device 600 includes the target data acquisition unit 611 that acquires the target data indicating the target excavation amount, and the evaluation data generation unit 604 generates the evaluation data based on the difference between the first detection data and the target data. For example, the target data may be set to an overflow rate of 1.0, and an overflow rate of the excavation amount indicated by the first detection data for the excavation amount corresponding to the overflow rate of 1.0 may be generated as the evaluation data. Alternatively, a score corresponding to the ratio of the first detection data to the target data may be generated as the evaluation data. In this way, it is possible to designate an arbitrary target excavation amount to evaluate the skill of the operator Ma in relation to the excavation amount. For example, when the operator Ma performs a loading operation of loading an excavation object on a cargo stand of a dump truck using the excavator 3, the operator Ma needs to finely adjust the excavation amount of the bucket 13 to obtain an appropriate loading amount. When the target excavation amount is designated and the skill of the operator Ma is evaluated based on the target excavation amount, it is possible to evaluate the skill of the actual loading operation of the operator Ma.

Moreover, according to the present embodiment, the excavation amount of the bucket 13 is calculated from the area of the excavation object protruding from the opening end 13K of the bucket 13, calculated by performing image processing on the photographic data of the bucket 13 photographed by the photographing device 63. In this way, it is possible to calculate the excavation amount of the bucket 13 in a simple manner without requiring complex processing. According to the present embodiment, it is possible to evaluate whether the operator Ma could excavate an appropriate amount of soil with the bucket 13 in one excavation operation in a short period and to evaluate the efficiency of the excavation operation of the operator Ma.

### Other Embodiment

In the above-described embodiment, the operation data of the bucket 13 is detected by the photographing device 63. The operation data of the bucket 13 may be detected by a scanner device such as radar, for example, capable of emitting a detection beam to detect the operation data of the bucket 13. Alternatively, the operation data may be detected by a radar device capable of irradiating the bucket 13 with radio waves to detect the operation data of the bucket 13.

The operation data of the bucket 13 may be detected by a sensor provided in the excavator 3. FIG. 26 is a diagram schematically illustrating an example of an excavator 3C having a detection device 63C that detects the operation data of the bucket 13.

The detection device 63C detects a relative position of the cutting edge 13B of the bucket 13 in relation to the upper swing structure 21. The detection device 63C includes a boom cylinder stroke sensor 14S, an arm cylinder stroke sensor 15S, and a bucket cylinder stroke sensor 16S. The boom cylinder stroke sensor 14S detects boom cylinder length data indicating the stroke length of the boom cylinder 14. The arm cylinder stroke sensor 15S detects arm cylinder length data indicating the stroke length of the arm cylinder 15. The bucket cylinder stroke sensor 16S detects bucket cylinder length data indicating the stroke length of the bucket cylinder 16. An angular sensor may be used as the detection device 63C instead of these stroke sensors.

The detection device 63C calculates an inclination angle θ1 of the boom 11 in relation to a direction parallel to the swing axis RX of the upper swing structure 21 based on the boom cylinder length data. The detection device 63C calculates an inclination angle θ2 of the arm 12 in relation to the boom 11 based on the arm cylinder length data. The detection device 63C calculates an inclination angle θ3 of the cutting edge 13B of the bucket 13 in relation to the arm 12 based on the bucket cylinder length data. The detection device 63C calculates the relative position of the cutting edge 13B of the bucket 13 in relation to the upper swing structure 21 based on the inclination angle θ1, the inclination angle θ2, and the inclination angle θ3, and the known working unit dimensions (the length L1 of the boom 11, the length L2 of the arm 12, and the length L3 of the bucket 13). Since the detection device 63C can detect the relative position of the bucket 13 in relation to the upper swing structure 21, it is possible to detect the moving state of the bucket 13.

According to the detection device 63C, it is possible to detect at least the position, the movement trajectory, the moving speed, and the moving time of the bucket 13 among the items of operation data of the bucket 13. The excavation amount [m³] of the bucket 13 may be obtained based on the detected weight detected by a weight sensor provided in the bucket 13.

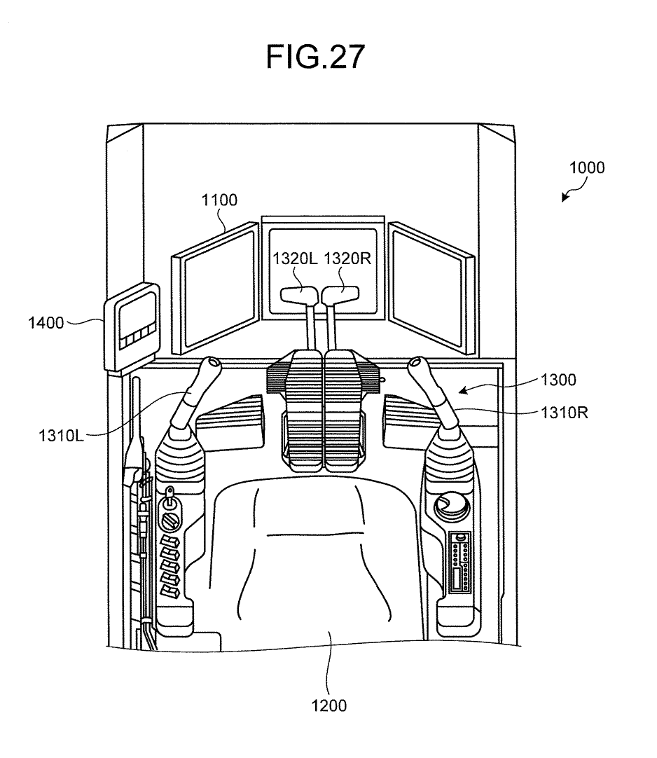

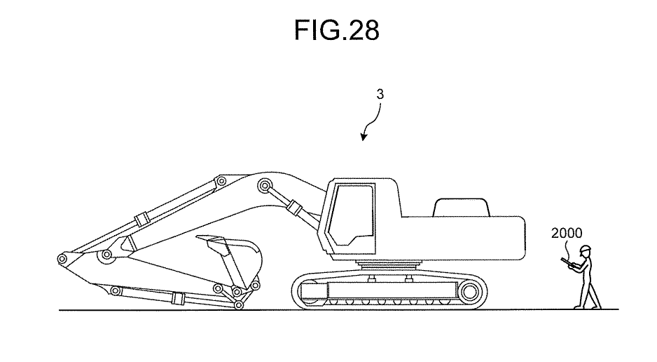

In the above-described embodiment, the operator Ma sits on the driver's seat 7 to operate the working unit 10. However, the working unit 10 may be controlled at a remote site. FIGS. 27 and 28 are diagrams for describing an example of a method for remote control of the excavator 3.

FIG. 27 is a diagram illustrating a method in which the excavator 3 is remote-controlled from a remote control room 1000. The remote control room 1000 and the excavator 3 can wirelessly communicate via a communication device. As illustrated in FIG. 27, a construction information display device 1100, a driver's seat 1200, an operating device 1300 for remote-controlling the excavator 3, and a monitor device 1400 are provided in the remote control room 1000.

The construction information display device 1100 displays various items of data such as image data of a construction site, image data of the working unit 10, construction process data, and construction control data.

The operating device 1300 includes a right working lever 1310R, a left working lever 1310L, a right travel lever 1320R, and a left travel lever 1320L. When the operating device 1300 is operated, an operation signal is wirelessly transmitted to the excavator 3 based on an operation direction and an operation amount thereof. In this way, the excavator 3 is remote-controlled.

The monitor device 1400 is provided on an obliquely front side of the driver's seat 1200. Detection data detected by a sensor system (not illustrated) of the excavator 3 is wirelessly transmitted to the remote control room 1000 via a communication device, and display data based on the detection data is displayed on the monitor device 1400.

FIG. 28 is a diagram illustrating a method in which the excavator 3 is remote-controlled by a mobile terminal device 2000. The mobile terminal device 2000 includes a construction information display device, an operating device for remote-controlling the excavator 3, and a monitor device.

When the operation data of the excavator 3 which is remote-controlled is acquired, it is possible to evaluate the skill of the operator Ma who remote-controls the excavator 3.

In the above-described embodiment, the management device 4 may have some or all of the functions of the evaluation device 600. When the operation data of the excavator 3 detected by the detection device 63 is transmitted to the management device 4 via the communication device 67, the management device 4 can evaluate the skill of the operator Ma based on the operation data of the excavator 3. Since the management device 4 has the arithmetic processing device 40 and the storage device 41 that can store a computer program that performs the evaluation method according to the present embodiment, the management device 4 can perform the function of the evaluation device 600.

In the above-described embodiment, the skill of the operator Ma is evaluated based on the operation data of the working unit 10. The operating state of the working unit 10 may be evaluated based on the operation data of the working unit 10. For example, an inspection process of determining whether the operating state of the working unit 10 is normal or not may be performed based on the operation data of the working unit 10.

In the above-described embodiment, the working vehicle 3 was the excavator 3. However, the working vehicle 3 may be a working vehicle having a working unit that can move in relation to the vehicle body, such as a bulldozer, a wheel loader, and a forklift.

### REFERENCE SIGNS LIST

1 EVALUATION SYSTEM
2 CONSTRUCTION SITE
3 EXCAVATOR (WORKING VEHICLE)
3C EXCAVATOR (WORKING VEHICLE)
4 MANAGEMENT DEVICE (FIRST SERVER)
6 MOBILE DEVICE
7 DRIVER'S SEAT
8 OPERATING DEVICE
8WR RIGHT WORKING LEVER
8WL LEFT WORKING LEVER
8MR RIGHT TRAVEL LEVER
8ML LEFT TRAVEL LEVER
10 WORKING UNIT
11 BOOM
11P BOOM PIN
12 ARM
12P ARM PIN
13 BUCKET
13B CUTTING EDGE
13K OPENING END
13P BUCKET PIN
14 BOOM CYLINDER
14S BOOM CYLINDER STROKE SENSOR
15 ARM CYLINDER
15S ARM CYLINDER STROKE SENSOR
16 BUCKET CYLINDER
16S BUCKET CYLINDER STROKE SENSOR
20 VEHICLE BODY
21 UPPER SWING STRUCTURE
22 LOWER TRAVELING BODY
23 CAB
24 COUNTERWEIGHT
25 DRIVE WHEEL
26 IDLER WHEEL
27 CRAWLER
40 ARITHMETIC PROCESSING DEVICE
41 STORAGE DEVICE
42 OUTPUT DEVICE
43 INPUT DEVICE
44 INPUT AND OUTPUT INTERFACE DEVICE
45 COMMUNICATION DEVICE
60 ARITHMETIC PROCESSING DEVICE (EVALUATION DEVICE)
61 STORAGE DEVICE
62 POSITION DETECTION DEVICE
63 PHOTOGRAPHING DEVICE
63C DETECTION DEVICE
64 DISPLAY DEVICE
65 INPUT DEVICE
66 INPUT AND OUTPUT INTERFACE DEVICE
67 COMMUNICATION DEVICE
70 GUIDE LINE
73 PHOTOGRAPHING REGION
600 EVALUATION DEVICE
601 DETECTION DATA ACQUISITION UNIT
602 POSITION DATA CALCULATION UNIT
603 TARGET DATA GENERATION UNIT
604 EVALUATION DATA GENERATION UNIT
605 DISPLAY CONTROL UNIT
608 STORAGE UNIT
610 INPUT AND OUTPUT UNIT
611 TARGET DATA ACQUISITION UNIT
613 EXCAVATION PERIOD CALCULATION UNIT
614 EXCAVATION AMOUNT CALCULATION UNIT
1000 REMOTE CONTROL ROOM
1100 CONSTRUCTION INFORMATION DISPLAY DEVICE
1200 DRIVER'S SEAT
1300 OPERATING DEVICE
1310R RIGHT WORKING LEVER
1310L LEFT WORKING LEVER
1320R RIGHT TRAVEL LEVER
1320L LEFT TRAVEL LEVER
1400 MONITOR DEVICE
2000 MOBILE TERMINAL DEVICE
AX1 ROTATION AXIS
AX2 ROTATION AXIS
AX3 ROTATION AXIS
DX1 ROTATION AXIS
DX2 ROTATION AXIS
EP MOVEMENT ENDING POSITION
Ma OPERATOR
Mb WORKER
MD CHARACTER DATA
PD PLOT
PM PLOT
RL TARGET LINE
RX SWING AXIS
SP MOVEMENT STARTING POSITION
TD ELAPSED TIME DATA
TL DETECTION LINE

1. An evaluation device comprising:
a detection data acquisition unit that acquires detection data including a detected movement trajectory of a predetermined portion of a working unit of a working vehicle based on operation data of the working unit from a movement starting position to a movement ending position, detected by a detection device that detects an operation of the working unit;
a target data generation unit that generates target data including a target movement trajectory of the predetermined portion of the working unit; and
an evaluation data generation unit that generates evaluation data of an operator who operates the working unit based on the detection data and the target data.

2. The evaluation device according to claim 1, wherein
the detection data includes a detected movement trajectory of the working unit in a no-load state in an air after the working unit in a stopped state starts moving at the movement starting position until the working unit ends moving at the movement ending position.

3. The evaluation device according to claim 1, wherein
the target movement trajectory includes a straight line that connects the movement starting position and the movement ending position.

4. The evaluation device according to claim 1, wherein
the evaluation data generation unit generates the evaluation data based on a difference between the detected movement trajectory and the target movement trajectory.

5. The evaluation device according to claim 1, wherein
the detection data includes a distance between the movement starting position and the movement ending position, and
the evaluation data generation unit generates the evaluation data based on the distance.

6. The evaluation device according to claim 1, wherein
the detection data includes a moving time of the working unit from the movement starting position to the movement ending position, and
the evaluation data generation unit generates the evaluation data based on the moving time.

7. The evaluation device according to claim 1, wherein
the detection device includes a photographing device configured to photograph the working vehicle,
the operation data includes photographic data of the working unit,
the working unit is supported by a vehicle body of the working vehicle,
the operation data includes photographic data of a photographing region including the working vehicle photographed by the photographing device,
the evaluation device comprises a position data calculation unit that calculates position data of the working unit based on the photographic data of the photographing region, wherein
after the position data calculation unit moves a first template with respect to the photographing region and calculates position data of the vehicle body based on a correlation value between the first template and the photographic data of the vehicle body, the position data calculation unit moves a second template with respect to the photographing region and calculates position data of the working unit based on a correlation value between the second template and the photographic data of the working unit.

8. An evaluation device comprising:
a detection data acquisition unit that acquires, based on operation data of a working unit of a working vehicle, first detection data indicating an excavation amount of the working unit and second detection data indicating an excavation period of the working unit; and
an evaluation data generation unit that generates evaluation data of an operator who operates the working unit based on the first detection data and the second detection data.

9. The evaluation device according to claim 8, further comprising:
a target data acquisition unit that acquires target data indicating a target excavation amount of the working unit, wherein
the evaluation data generation unit generates the evaluation data based on a difference between the first detection data and the target data.

10. The evaluation device according to claim 8, wherein
the detection device includes a photographing device configured to photograph the working vehicle,
the operation data includes photographic data of the working unit,
the working unit includes a bucket, and
the evaluation device comprises an excavation amount calculation unit that performs image processing on the photographic data of the bucket photographed by the photographing device and calculates the excavation amount from an area of an excavation object protruding from an opening end of the bucket.

11. An evaluation method comprising:
acquiring detection data including a detected movement trajectory of a predetermined portion of a working unit of a working vehicle based on operation data of the working unit from a movement starting position to a movement ending position of the working unit, detected by a detection device that detects an operation of the working unit;
generating target data including a target movement trajectory of the predetermined portion of the working unit; and
generating evaluation data of an operator who operates the working unit based on the detection data and the target data.

12. An evaluation method comprising:
acquiring first detection data indicating an excavation amount of a working unit of a working vehicle and second detection data indicating an excavation period of the working unit based on operation data of the working unit; and
generating evaluation data of an operator who operates the working unit based on the first detection data and the second detection data.
